(19) United States
(12) Patent Application Publication
(10) Pub. No.: US 2021/0056878 A1
(43) Pub. Date: Feb. 25, 2021

(54) ELECTRONIC DEVICE HAVING FOLDABLE DISPLAY AND METHOD OF GENERATING CONTENT THEREOF

(71) Applicant: Samsung Electronics Co., Ltd., Gyeonggi-do (KR)

(72) Inventors: Won LEE, Gyeonggi-do (KR); Bokeun KIM, Gyeonggi-do (KR); Younghak OH, Gyeonggi-do (KR); Kyuok CHOI, Gyeonggi-do (KR)

(21) Appl. No.: 16/930,699

(22) Filed: Jul. 16, 2020

(30) Foreign Application Priority Data
Aug. 19, 2019 (KR) 10-2019-0101360

(51) Int. Cl. G09G 3/00; G06F 3/041; G09G 5/36

(52) U.S. Cl. CPC G09G 3/035; G06F 3/041; G09G 5/36; G06F 3/04817; G09G 2354/00; G09G 2380/02; G06F 2203/04108

(57) ABSTRACT

An electronic device is disclosed herein. The electronic device may include a housing, a display that is foldable disposed on one face of the housing, memory, and a processor operatively connected to the display and the memory, wherein the memory includes instructions that, when executed, cause the processor to: generate at least one content based on user input on the display when the display is disposed in a folded state, detect unfolding of the display from the folded state to an unfolded state, and display at least one graphic object corresponding to the at least one generated content on at least a portion of the display when the first display is disposed in the unfolded state.

### CROSS-REFERENCE TO RELATED APPLICATION(S)

This application is based on and claims priority under 35 U.S.C. 119 to Korean Patent Application No. 10-2019-0101360, filed on Aug. 19, 2019, in the Korean Intellectual Property Office, the disclosure of which is herein incorporated by reference in its entirety.

### BACKGROUND

### 1) Field

Certain embodiments relate to an electronic device. For example, certain embodiments relate to an electronic device, and more particularly, to an electronic device including a foldable display.

### 2) Description of Related Art

With the development of mobile communication technology and hardware/software technology, it has become possible to incorporate various functions in portable electronic devices (hereinafter referred to as an “electronic device”) represented by smart phones. The electronic device may include a touch screen-based display, enabling easy access of the various functions, and may provide execution screens of various applications through the display.

In recent years, in order to increase portability, displays have been further developed, encompassing not only a flexible form, but also completely foldable displays. For electronic devices having these foldable displays, it is possible to use the larger area of the unfolded display to provide a larger display. It is also possible to reduce the size of the electronic device by disposing it in the folded state. Accordingly, it is possible to improve both the usability and portability of the electronic device using foldable displays.

The above information is presented as background information only to assist with an understanding of the disclosure. No determination has been made, and no assertion is made, as to whether any of the above might be applicable as prior art with regard to the disclosure.

### SUMMARY

An electronic device including a foldable display may be frequently switched between a folded state and an unfolded state, and may generate various contents based on user input on the display in each of the folded and unfolded states.

Certain embodiments disclosed herein have an object to provide an electronic device which allows a user to easily identify and edit a content generated in the folded state when the electronic device is switched to the unfolded state, and to provide a method for generating a content of the electronic device.

An electronic device according to certain embodiments may include: a housing including a first face and a second face, a first display that is foldable, disposed on the first face of the housing, a second display disposed on at least a portion of the second face of the housing, a memory, and a processor operatively connected to the first display, the second display, and the memory, wherein the memory includes instructions that, when executed, cause the processor to: generate at least one content based on a user input on the second display when the first display is disposed in a folded state, detect unfolding of the first display from the folded state to an unfolded state, and display at least one graphic object corresponding to the at least one generated content on at least a portion of the first display when the first display is disposed in the unfolded state.

According to certain embodiments, a method for an electronic device an having a foldable first display and a second display is disclosed, the method including: generating at least one content based on a user input on the second display when the first display is disposed in a folded state, detecting unfolding of the first display from the folded state to an unfolded state, and displaying at least one graphic object corresponding to the at least one generated content on at least a portion of the first display when the first display is disposed in the unfolded state.

An electronic device according to certain embodiments may include: a housing, a display that is foldable disposed on one face of the housing, memory, and a processor operatively connected to the display and the memory, wherein the memory includes instructions that, when executed, cause the processor to: generate at least one content based on user input on the display when the display is disposed in a folded state, detect unfolding of the display from the folded state to an unfolded state; and display at least one graphic object corresponding to the at least one generated content on at least a portion of the display when the first display is disposed in the unfolded state.

Certain embodiments disclosed herein may provide an electronic device which allows a user to easily identify and edit a content generated in the folded state when the electronic device is switched to the unfolded state, and are capable of providing a method for generating a content of the electronic device.

### BRIEF DESCRIPTION OF THE DRAWINGS

For a more complete understanding of the disclosure and its advantages, reference is now made to the following description taken in conjunction with the accompanying drawings, in which like reference numerals represent like parts:

FIG. 1 is a block diagram of an electronic device according to certain embodiments in a network environment;

FIG. 2A is a view illustrating an electronic device according to certain embodiments in an unfolded state, and FIG. 2B is a view illustrating an electronic device according to certain embodiments in a folded state;

FIG. 3 is an exploded perspective view illustrating an electronic device according to certain embodiments.

FIG. 4A is a view illustrating a use state in a folding or unfolding operation in an electronic device according to certain embodiments, FIG. 4B is a view illustrating a use state in a folding or unfolding operation in an electronic device according to certain embodiments, FIG. 4C is a view illustrating a use state in a folding or unfolding operation in an electronic device according to certain embodiments, and FIG. 4D is a view illustrating a use state in a folding or unfolding operation in an electronic device according to certain embodiments;

FIG. 5A is a view illustrating a stylus pen of an electronic device according to certain embodiments, and FIG. 5B is a view illustrating a stylus pen of an electronic device according to certain embodiments;

FIG. 6 is a block diagram of an electronic device according to certain embodiments;

FIG. 7A illustrates an example of a content generated in a folded state according to certain embodiments, FIG. 7B illustrates an example of a content generated in a folded state according to certain embodiments, and FIG. 7C illustrates an example of a content generated in a folded state according to certain embodiments;

FIG. 8A illustrates a method of storing contents generated in a folded state according to certain embodiments, and FIG. 8B illustrates a method of storing contents generated in a folded state according to certain embodiments;

FIG. 9A illustrates a method of editing a content storage space according to certain embodiments, and FIG. 9B illustrates a method of editing a content storage space according to certain embodiments;

FIG. 10A illustrates a screen displayed when an electronic device according to certain embodiments is unfolded, FIG. 10B illustrates a screen displayed when an electronic device according to certain embodiments is unfolded, and FIG. 10C illustrates a screen displayed when an electronic device according to certain embodiments is unfolded;

FIG. 11A illustrates a method of displaying a content in the state in which an electronic device according to certain embodiments is unfolded, FIG. 11B illustrates a method of displaying a content in the state in which an electronic device according to certain embodiments is unfolded, and FIG. 11C illustrates a method of displaying a content in the state in which an electronic device according to certain embodiments is unfolded;

FIG. 12A illustrates a method of displaying multiple contents together in the state in which an electronic device according to certain embodiments is unfolded, and FIG. 12B illustrates a method of displaying multiple contents together in the state in which an electronic device according to certain embodiments is unfolded;

FIG. 13A illustrates a method of displaying a content dock in the state in which an electronic device according to certain embodiments is unfolded, and FIG. 13B illustrates a method of displaying a content dock in the state in which an electronic device according to certain embodiments is unfolded;

FIG. 14A is a view illustrating a method of editing a content according to certain embodiments, and FIG. 14B is a view illustrating a method of editing a content according to certain embodiments;

FIG. 15A is a view illustrating a method of editing a content according to certain embodiments and FIG. 15B is a view illustrating a method of editing a content according to certain embodiments; and

FIG. 16 is a flowchart illustrating a method of generating a content of an electronic device according to certain embodiments.

### DETAILED DESCRIPTION

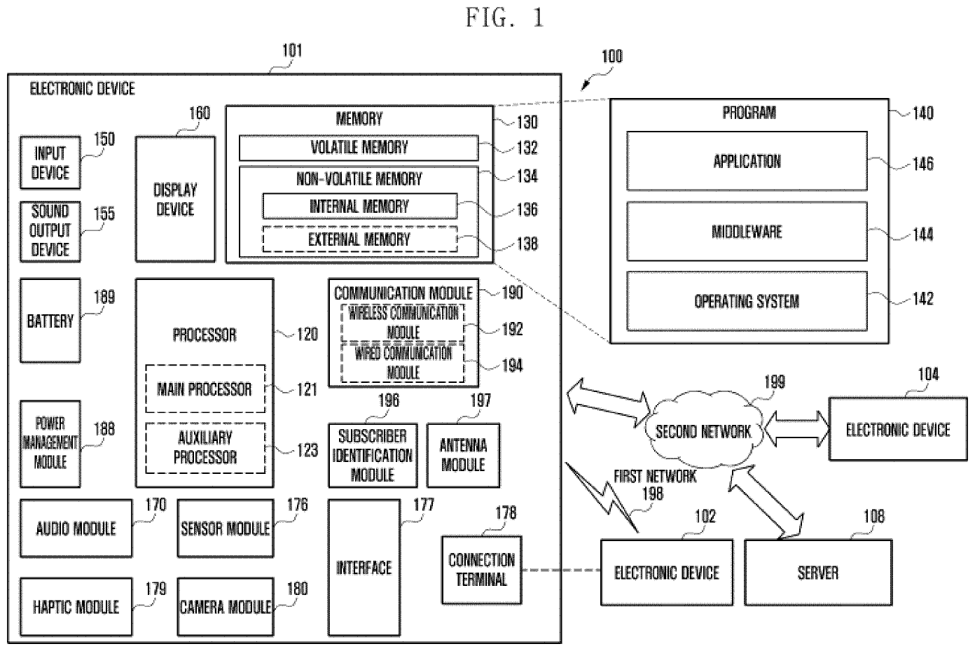

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

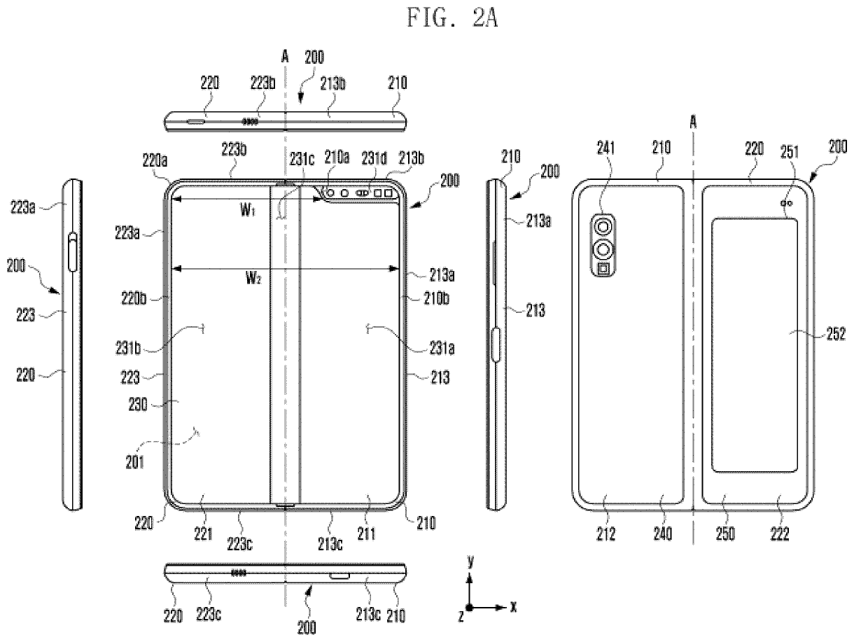

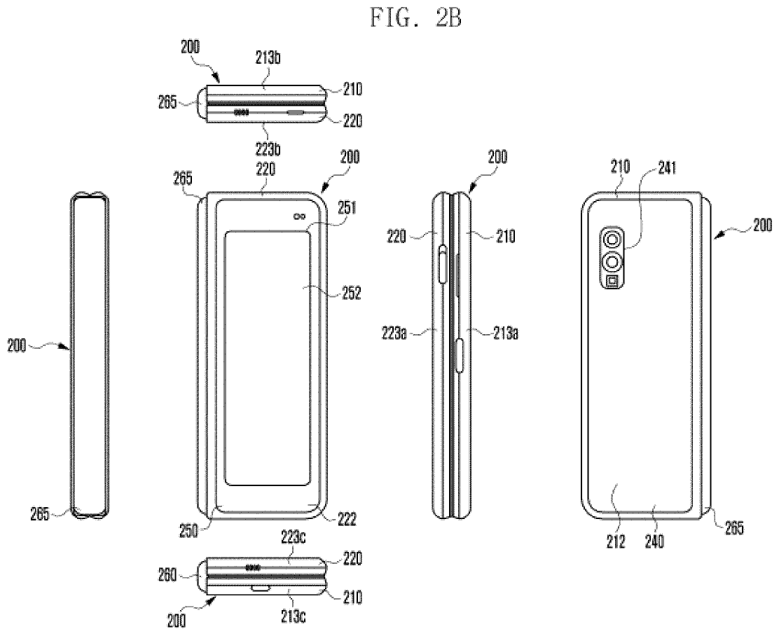

FIG. 2A is a view illustrating an electronic device according to certain embodiments in an unfolded state.

According to certain embodiments, an electronic device may include a first display and a second display, which are separated from each other. The first display may be foldable, and the second display may not be foldable.

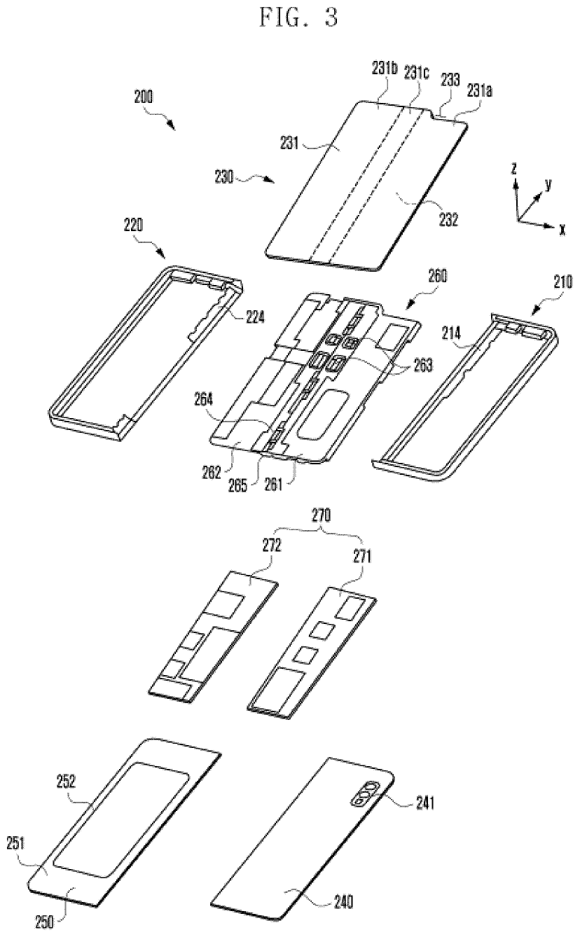

Referring to FIG. 2A, the electronic device 200 may include a pair of housing structures 210 and 220 rotatably coupled to each other via a hinge structure (e.g., the hinge structure 264 in FIG. 3) so as to be folded with respect to each other, a hinge cover 265 configured to cover the foldable portions of the pair of housing structures 210 and 220, and a display 230 (or a first display) (e.g., a flexible display or a foldable display) disposed in a space formed by the pair of housing structures 210 and 220. Herein, the face on which the display 230 is disposed may be defined as a front face (or a first face) of the electronic device 200, and the face opposite the front face may be defined as a rear face (or a second face) of the electronic device 200. In addition, the face surrounding the space between the front face and the rear face may be defined as a side face of the electronic device 200.

In an embodiment, the pair of housing structures 210 and 220 may include a first housing structure 210 including a sensor region 231d, a second housing structure 220, a first rear cover 240, and a second rear cover 250. The pair of housing structures 210 and 220 of the electronic device 200 are not limited to the shape and assembly illustrated in FIGS. 2A and 2B, but may be implemented by other shapes or other combinations and/or assemblies of components. For example, in another embodiment, the first housing structure 210 and the first rear cover 240 may be integrally formed, and the second housing structure 220 and the second rear cover 250 may be integrally formed.

According to an embodiment, the first housing structure 210 and the second housing structure 220 may be disposed on opposite sides about a folding axis (the axis A), and may have generally symmetrical shapes with respect to the folding axis (the axis A). According to an embodiment, the angle or distance between the first housing structure 210 and the second housing structure 220 may vary depending on whether the electronic device 200 is in the unfolded state (the flat state), in the folded state (the closed state), or in the intermediate state. According to an embodiment, unlike the second housing structure 220, the first housing structure 210 may further include a sensor region 231d in which various sensors are disposed. However, the first housing structure 210 and the second housing structure 220 may have mutually symmetrical shapes in the other regions. In another embodiment, the sensor region 231d may be further disposed in or replaced with at least a partial region of the second housing structure 220.

In an embodiment, in the unfolded state of the electronic device 200, the first housing structure 210 may include a first face 211 connected to the hinge structure (e.g., the hinge structure 264 in FIG. 3) and arranged to face the front side of the electronic device 200, a second face 212 facing away from the first face 211, and a first side member 213 surrounding at least a portion of the space between the first face 211 and the second face 212. In an embodiment, the first side member 213 may include a first side face 213a arranged parallel to the folding axis (the axis A), a second side face 213b extending from one end of the first side face 213a in a direction perpendicular to the folding axis, and a third face 213c extending from the other end of the first side face 213a in a direction perpendicular to the folding axis (the axis A).

In an embodiment, in the unfolded state of the electronic device 200, the second housing structure 220 may include a third face 221 connected to the hinge structure (e.g., the hinge structure 264 in FIG. 3) and arranged to face the front side of the electronic device 200, a fourth face 222 facing away from the third face 221, and a second side member 223 surrounding at least a portion of the space between the third face 221 and the fourth face 222. In an embodiment, the second side member 223 may include a fourth side face 223a arranged parallel to the folding axis (the axis A), a fifth side face 223b extending from one end of the fourth side face 223a in a direction perpendicular to the folding axis (the axis A), and a sixth side face 223c extending from the other end of the fourth side face 223a in a direction perpendicular to the folding axis (the axis A). In an embodiment, in the folded state, the third face 221 may face the first face 211.

In an embodiment, the electronic device 200 may include a recess 201 formed to accommodate the display 230 through structural shape coupling between the first housing structure 210 and the second housing structure 220. The recess 201 may have substantially the same size as the display 230. In an embodiment, due to the sensor region 231d, the recess 201 may have two or more different widths in a direction perpendicular to the folding axis (the axis A). For example, the recess 201 may have a first width W₁ between a first portion 220a of the second housing structure 220, which is parallel to the folding axis A, and a first portion 210a formed at an edge of the sensor region 231d of the first housing structure 210, and a second width W₂ between a second portion 220b of the second housing structure 220 and a second portion 210b of the first housing structure 210, which does not correspond to the sensor region 213d and is parallel to the folding axis (the axis A). In this case, the second width W₂ may be longer than the first width W₁. For example, the recess 201 may be formed to have the first width W₁ between the first portion 210a of the first housing structure 210 and the first portion 220a of the second housing structure 220, which are asymmetric to each other, and the second width W₂ between the second portion 210b of the first housing structure 210 and the second portion 220b of the second housing structure 220, which are symmetric to each other. In an embodiment, the first portion 210a and the second portion 210b of the first housing structure 210 may have different distances from the folding axis (the axis A). The widths of the recess 201 are not limited to the illustrated example. In certain embodiments, the recess 201 may have two or more different widths due to the shape of the sensor region 213d or the asymmetric portions of the first housing structure 210 and the second housing structure 220.

In an embodiment, at least a portion of the first housing structure 210 and at least a portion of the second housing structure 220 may be formed of a metal material or a non-metal material having rigidity, the level of which is selected in order to support the display 230.

In an embodiment, the sensor region 231d may be formed to have a predetermined area adjacent to one corner of the first housing structure 210. However, the arrangement, shape, and size of the sensor region 231d is not limited to the illustrated example. For example, in another embodiment, the sensor region 231d may be provided at another corner of the first housing structure 210 or in any region between the upper and lower end corners. In another embodiment, the sensor region 231d may be disposed in a partial region of the second housing structure. In another embodiment, the sensor region 231d may be disposed to extend over the first housing structure 210 and the second housing structure 220. In an embodiment, the electronic device 200 may include components for performing various functions. The components may be exposed to the front face of the electronic device 200 through the sensor region 231d or through one or more openings provided in the sensor region 231d. In certain embodiments, the components may include, for example, at least one of a front camera device, a receiver, a proximity sensor, an illuminance sensor, an iris recognition sensor, an ultrasonic sensor, or an indicator.

In an embodiment, the first rear cover 240 may be disposed on the second face 212 of the first housing structure 210, and may have a substantially rectangular periphery. In an embodiment, at least a portion of the periphery may be surrounded by the first housing structure 210. Similarly, the second rear cover 250 may be disposed on the fourth face 222 of the second housing structure 220, and at least a portion of the periphery of the second rear cover 250 may be surrounded by the second housing structure 220.

In the illustrated embodiment, the first rear cover 240 and the second rear cover 250 may have substantially symmetrical shapes about the folding axis (the axis A). According to another embodiment, the first rear cover 240 and the second rear cover 250 may have various different shapes. In another embodiment, the first rear cover 240 may be integrally formed with the first housing structure 210, and the second rear cover 250 may be integrally formed with the second housing structure 220.

In an embodiment, the first rear cover 240, the second rear cover 250, the first housing structure 210, and the second housing structure 220 may provide, through a mutually coupled structure, a space in which various components (e.g., a printed circuit board, an antenna module, a sensor module, or a battery) of the electronic device 200 may be arranged. In an embodiment, one or more components may be disposed or visually exposed on the rear face of the electronic device 200. For example, one or more components or sensors may be visually exposed through a first rear region 241 of the first rear cover 240. In certain embodiments, the sensors may include a proximity sensor, a rear camera, and/or a flash. In another embodiment, at least a portion of a sub-display 252 (or a second display) may be visually exposed through a second rear region 251 of the second rear cover 250.

The display 230 may be disposed in a space formed by the foldable housing structures 210 and 220. For example, the display 230 may be seated in the recess (e.g., the recess 201 in FIG. 2A) formed by the pair of housing structures 210 and 220, and may be disposed to occupy substantially the majority of the front face of the electronic device 200. Accordingly, the front face of the electronic device 200 may include the display 230, as well as a partial region (e.g., a peripheral region) of the first housing structure 210 and a partial region (e.g., a peripheral region) of the second housing structure 220, which are adjacent to the display 230. In an embodiment, the rear face of the electronic device 200 may include the first rear cover 240 and a partial region (e.g., a peripheral region) of the first housing structure 210 adjacent to the first rear cover 240, as well as the second rear cover 250 and a partial region (e.g., a peripheral region) of the second housing structure 220 adjacent to the second rear cover 250.

According to an embodiment, the display 230 may mean a display in which at least one region is deformable into a planar face or a curved face. In an embodiment, the display 230 may include a folding region 231c, a first region 231a disposed on one side of the folding region 231c (e.g., the right region of the folding region 231c), and a second region 231b disposed on the other side of the folding region 231c (e.g., the left region of the folding region 231c). For example, the first region 231a may be disposed in the first face 211 of the first housing structure 210, and the second region 231b may be disposed in the third face 221 of the second housing structure 220. In an embodiment, the region division of the display 230 as described is provided as an example, and the display 230 may be divided into multiple regions (e.g., four or more regions or two regions) depending on the structure or functions thereof. For example, in the embodiment illustrated in FIG. 2A, the regions of the display 230 may be divided by the folding region 231c or the folding axis (the axis A) extending parallel to the y axis. However, in another embodiment, the regions of the display 230 may be divided based on another folding region (e.g., a folding region parallel to the x axis) or another folding axis (e.g., a folding axis parallel to the x axis). The aforementioned region division of the display is merely physical division based on the pair of housing structures 210 and 220 and the hinge structure (e.g., the hinge structure 264 in FIG. 3), and the display 230 may display one full screen substantially through the pair of housing structures 210 and 220 and the hinge structure (e.g., the hinge structure 264 in FIG. 3). According to an embodiment, the first region 231a and the second region 231b may have generally symmetrical shapes about the folding region 231c. However, unlike the second region 231b, the first region 231a may include a cut notch region (e.g., the notch region 233 in FIG. 3), depending on the existence of the sensor region 231d. The first region 231a may have a shape symmetrical to the first region 231a in the region other than the notch region. In other words, the first region 231a and the second region 231b may include mutually symmetrical portions and mutually asymmetrical portions.

FIG. 2B is a view illustrating the electronic device according to certain embodiments in a folded state.

Referring to FIG. 2B, the hinge cover 265 may be disposed between the first housing structure 210 and the second housing structure 220 so as to cover internal components (e.g., the hinge structure 264 in FIG. 3). In an embodiment, the hinge cover 265 may be covered by a portion of the first housing structure 210 and a portion of the second housing structure 220 or may be exposed to the outside depending on the operating state of the electronic device 200 (the unfolded state or the folded state).

For example, as illustrated in FIG. 2A, when the electronic device 200 is in the unfolded state, the hinge cover 265 may not be exposed by being covered by the first housing structure 210 and the second housing structure 220. For example, as illustrated in FIG. 2B, when the electronic device 200 is in the folded state (e.g., the fully folded state), the hinge cover 265 may be exposed to the outside between the first housing structure 210 and the second housing structure 220. For example, when the first housing structure 210 and the second housing structure 220 are in the intermediate state in which the first housing structure 210 and the second housing structure 220 form a predetermined angle therebetween, the hinge cover 265 may be partially exposed to the outside between the first housing structure 210 and the second housing structure 220. In this case, the exposed region may be smaller than that in the completely folded state. In an embodiment, the hinge cover 265 may include a curved face.

Hereinafter, the operation of the first housing structure 210 and the second housing structure 220 and respective regions of the display 230 depending on the operating states (e.g., the unfolded state and the folded state) of the electronic device 200 will be described.

In an embodiment, when the electronic device 200 is in the unfolded state (flat state) (e.g., the state of FIG. 2A), the first housing structure 210 and the second housing structure 220 may form an angle of 180 degrees therebetween, and the first region 231a and the second region 231b of the display may be oriented in the same direction. In addition, the folding region 231c may form the same plane as the first region 231a and the second region 232b.

In an embodiment, when the electronic device 200 is in the folded state (e.g., the state of FIG. 2B), the first housing structure 210 and the second housing structure 220 may be disposed to face each other. The first region 231a and the second region 231b of the display 230 may form a narrow angle (e.g., an angle between 0 and 10 degrees) relative to each other. At least a portion of the folding region 231c may be formed in a curved face having a predetermined curvature.

In an embodiment, when the electronic device 200 is in the intermediate state, the first housing structure 210 and the second housing structure 220 may be disposed so as to form a predetermined angle therebetween. For example, the first region 231a and the second region 231b of the display 230 may form an angle greater than that in the folded state and smaller than that in the unfolded state. At least a portion of the folding region 231c may be formed in a curved face having a predetermined curvature, and the curvature in this case may be smaller than that in the folded state.

FIG. 3 is an exploded perspective view illustrating an electronic device according to certain embodiments.

Referring to FIG. 3, in an embodiment, the electronic device 200 may include a display 230, a bracket assembly 260, at least one printed circuit board 270, a first housing structure 210, a second housing structure 220, a first rear cover 240, and a second rear cover 250. Herein, the display unit 230 may be referred to as a display module or a display assembly.

The display (or the first display) 230 may include a display panel 231 (e.g., a flexible display panel), and at least one plate 232 or layer on which the display panel 231 is seated. In an embodiment, the plate 232 may be disposed between the display panel 231 and the bracket assembly 260. The display panel 231 may be disposed on at least a portion of one face (e.g., the face in the Z direction in FIG. 3) of the plate 232. The plate 232 may be formed in a shape corresponding to that of the display panel 231. For example, a region of the plate 232 may be formed in a shape corresponding to that of the notch region 233 in the display panel 231.

The bracket assembly 260 may include a first bracket 261, a second bracket 262, a hinge structure 264 disposed between the first bracket 261 and the second bracket 262, a hinge cover 265 configured to cover the hinge structure 264 when the hinge structure 264 is viewed from the outside, and a wiring member 263 (e.g., a flexible printed circuit board (FPCB)) extending across the first and second brackets 261 and 262.

In an embodiment, the bracket assembly 260 may be disposed between the plate 232 and at least one printed circuit board 270. For example, the first bracket 261 may be disposed between the first region 231a of the display 230 and a first printed circuit board 271. The second bracket 262 may be disposed between the second region 231b of the display 230 and a second printed circuit board 272.

According to an embodiment, at least a portion of the wiring member 263 and at least a portion of the hinge structure 264 may be disposed inside the bracket assembly 260. The wiring member 263 may be disposed in a direction across the first bracket 261 and the second bracket 262 (e.g., the x-axis direction). The wiring member 263 may be disposed in a direction (e.g., the x-axis direction) perpendicular to the folding axis (e.g., they axis or the folding axis A in FIG. 1) of the folding region 231c.

As described above, the at least one printed circuit board 270 may include a first printed circuit board 271 disposed on the first bracket 261 side and a second printed circuit board 272 disposed on the second bracket 262 side. The first printed circuit board 271 and the second printed circuit board 272 may be disposed inside a space formed by the bracket assembly 260, the first housing structure 210, the second housing structure 220, the first rear cover 240, and the second rear cover 250. Components for implementing various functions of the electronic device 200 may be mounted on the first printed circuit board 271 and the second printed circuit board 272.

In an embodiment, the first housing structure 210 and the second housing structure 220 may be assembled so as to be coupled to the opposite sides of the bracket assembly 260 in the state in which the display 230 is coupled to the bracket assembly 260. As will be described later, the first housing structure 210 and the second housing structure 220 may be coupled to the bracket assembly 260 by sliding on the opposite sides of the bracket assembly 260.

In an embodiment, the first housing structure 210 may include a first rotational support face 214, and the second housing structure 220 may include a second rotational support face 224, which corresponds to the first rotational support structure 214. The first rotational support face 214 and the second rotational support face 224 may include curved faces corresponding to curved faces included in the hinge cover 265.

In an embodiment, when the electronic device 200 is in the unfolded state (e.g., the state of FIG. 2A), the first rotational support face 214 and the second rotational support face 224 may cover the hinge cover 265 such that the hinge cover 265 is not exposed to the rear face of the electronic device 200 or is minimally exposed to the rear face of the electronic device 200. In an embodiment, when the electronic device 200 is in the folded state (e.g., the state of FIG. 2B), the first rotational support face 214 and the second rotational support face 224 may rotate along the curved faces included in the hinge cover 265 such that the hinge cover 265 is exposed to the rear face of the electronic device 200 as much as possible.

In an embodiment, a sub-display (or a second display) 252 may be mounted on the second rear cover 250 to be exposed to the outside through the rear face of the electronic device 200.

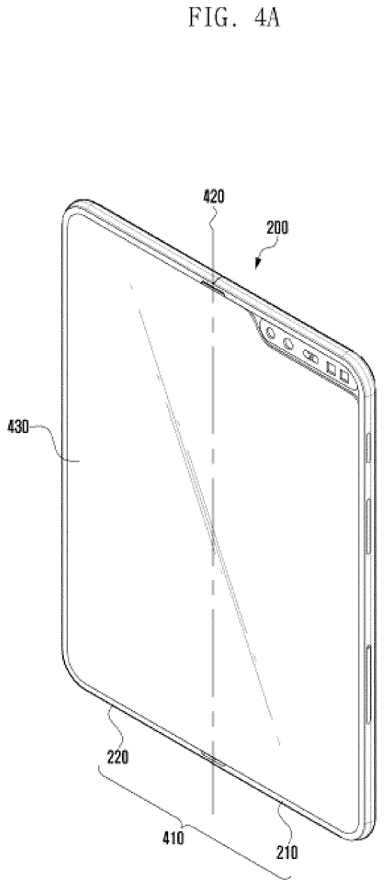

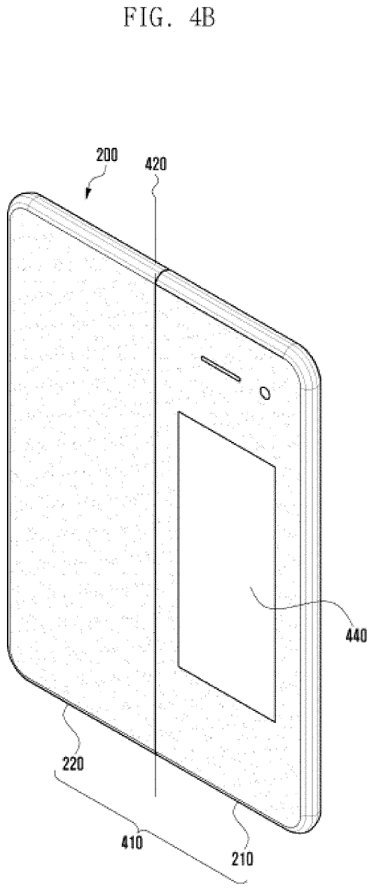

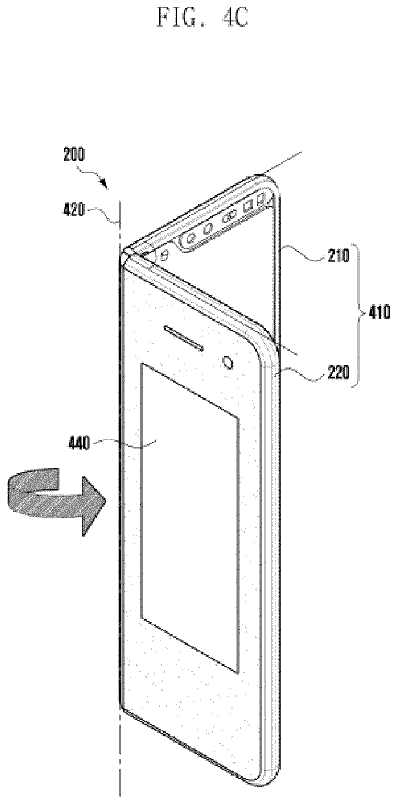

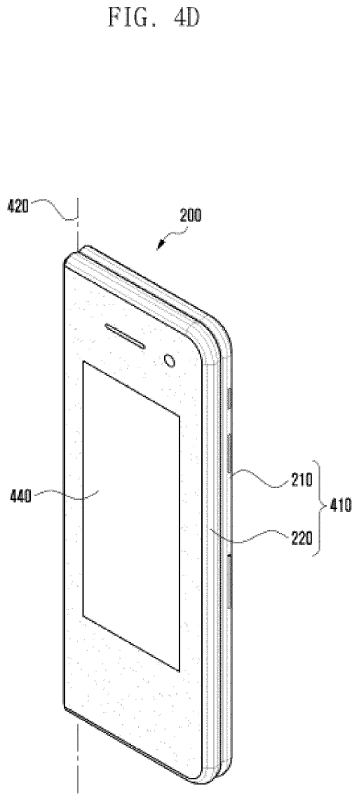

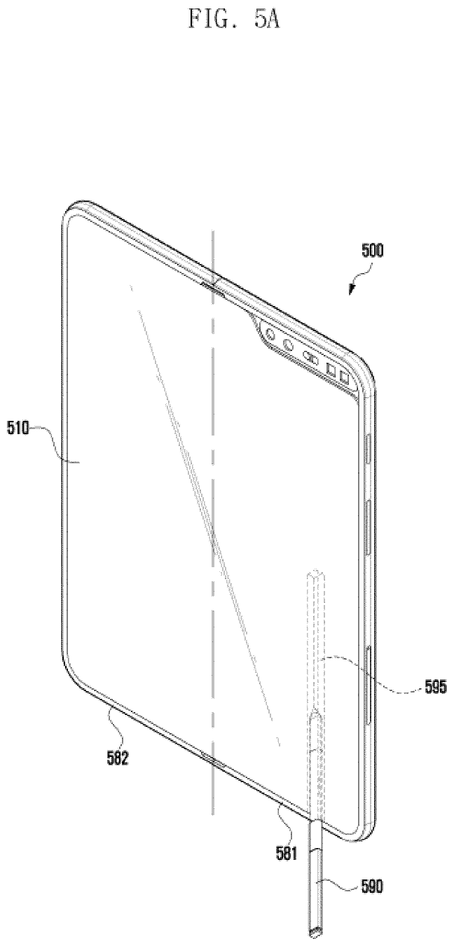

FIG. 4A is a view illustrating a use state in a folding or unfolding operation in an electronic device according to certain embodiments, FIG. 4B is a view illustrating a use state in a folding or unfolding operation in an electronic device according to certain embodiments, FIG. 4C is a view illustrating a use state in a folding or unfolding operation in an electronic device according to certain embodiments, and FIG. 4D is a view illustrating a use state in a folding or unfolding operation in an electronic device according to certain embodiments.

An electronic device 200 (e.g., the electronic device 101 of FIG. 1) according to certain embodiments may include a foldable housing 410, a first display 430 (e.g., the first display 230 in FIG. 2A), and a second display (e.g., the sub-display 252 in FIG. 2A).

According to certain embodiments, the electronic device 200 may include a foldable housing 410. The foldable housing 410 may include a first housing structure 210 and a second housing structure 220, which are connected to each other by a hinge structure (e.g., the hinge structure 264 in FIG. 3).

According to certain embodiments, the second housing structure 220 may be connected to be foldable from the first housing 210. The first housing structure 210 and the second housing structure 220 may be foldable to each other around a folding axis 420 (e.g., the folding axis (axis A) in FIG. 2A) extending in a first direction. The first housing structure 210 and the second housing structure 220 may be disposed so as to face each other in the state of being folded toward each other.

Referring to FIG. 4A, an angle formed between the first housing structure 210 and the second housing structure 220 may be about 180 degrees. As described above, when the angle formed between the first housing structure 210 and the second housing structure 220 is equal to or greater than a predetermined angle (e.g., about 170 degrees), the electronic device (or the first display 430) may be defined as an unfolded state. When the electronic device 200 is in the unfolded state, the first housing structure 210 and the second housing structure 220 may form a substantially flat structure.

Referring to FIG. 4B, according to certain embodiments, the electronic device 200 may further include a second display 440 (e.g., the sub-display 252 in FIG. 2A).

FIG. 4C is a view illustrating the electronic device 200 according to certain embodiments in the state of being partially folded counterclockwise around the folding axis 420, and FIG. 4D is a view illustrating the electronic device 200 according to certain embodiments in the state of being fully folded around the folding axis 420.

Referring to FIGS. 4C and 4D, a user of the electronic device 200 applies a force to the electronic device 200 to fold the electronic device 200, which is in the unfolded state, around the folding axis 420, or to unfold the electronic device 200, which is in the folded state, around the folding axis 420.

Although FIGS. 4A to 4D illustrate the structure in which the electronic device 200 is folded in the horizontal direction around the folding axis 420, the folding method of the electronic device 200 is not limited thereto. For example, the electronic device 200 may be folded in the form in which the upper face and the lower face are folded toward each other, that is, in a vertical folding type. In this case, the folding axis may be formed in the horizontal direction.

In addition, the electronic device 200 may be implemented in an out-folding type in which the folded display is exposed to the outside in the folded state.

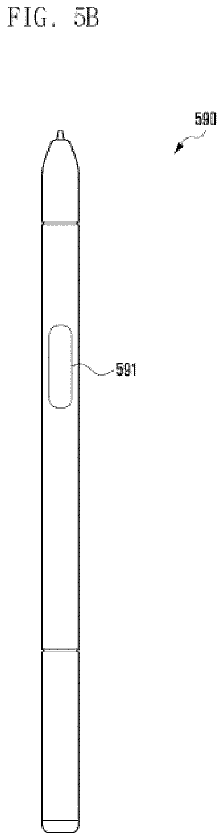

FIG. 5A is a view illustrating a stylus pen of an electronic device according to certain embodiments, and FIG. 5B is a view illustrating a stylus pen of an electronic device according to certain embodiments.

FIG. 5A is a view illustrating the external appearance of an electronic device 500 according to certain embodiments.

According to certain embodiments, the electronic device 500 may include a stylus pen 590. The stylus pen 590 may be used for touch input and/or hovering input on a touch screen (e.g., the first display 510 or the second display) of the electronic device 500.

According to certain embodiments, a portion of the housing of the electronic device 500, for example, a portion of the side face may include a hole. The electronic device 500 may include a recess 595 or an accommodation space connected to the hole, and the stylus pen 590 may be inserted into the recess 595. The recess 595 may have an elongated shape similar to the shape of the stylus pen 590 such that the stylus pen 590 can be inserted into or removed from the recess 595. The recess 595 may be provided at the bottom of the housing of the electronic device 500, but is not limited thereto. The recess 595 may be in a form into which the stylus pen 590 can be inserted from the top end or the side face.

According to certain embodiments, the recess 595 configured to insert the stylus pen 590 therein may be provided in one of the first housing structure 581 (e.g., the first housing structure 210 in FIG. 2) and the second housing structure 582 (e.g., the second housing structure 220 in FIG. 2) folded to face each other with reference to the folding axis when folded.

FIG. 5B is a view illustrating the external appearance of the electronic stylus device 590 according to certain embodiments.

As illustrated in FIG. 5B, the stylus pen 590 has a body having an overall elongated shape, and may be inserted into the recess 595 formed in a portion of the housing of the electronic device 500 to be removable from the electronic device 500.

According to certain embodiments, the stylus pen 590 may support touch input and/or hovering input on a display (e.g., the first display 510 or the second display) of the electronic device 500.

According to certain embodiments, the stylus pen 590 may include at least one button 591.

The stylus pen 590 may include a battery (not illustrated), and the battery of the stylus pen 590 may be charged from the electronic device 500 in a wired and/or wireless charging method in the state of being inserted into the electronic device 500. The electronic device 500 includes a sensor for detecting separation of the stylus pen 590, and when the stylus pen 590 is removed from the recess 595 in the electronic device 500, the electronic device 500, the electronic device 500 may perform an operation corresponding to removal (e.g., wireless communication connection or execution of a specific application execution).

According to certain embodiments, the electronic device 500 and the stylus pen 590 may be connected to each other through wireless communication (e.g., Bluetooth-Low-Energy (BLE)). For example, when the stylus pen 590 is removed from the recess 595 in the electronic device 500 or is inserted into the recess 595 in the electronic device 500, the electronic device may establish a wireless communication connection with the stylus pen 590. The stylus pen 590 may detect user input (e.g., button input, motion, or sound) using buttons and/or various sensors, and may provide a wireless signal corresponding to the user input to the electronic device 500 using a wireless communication connection.

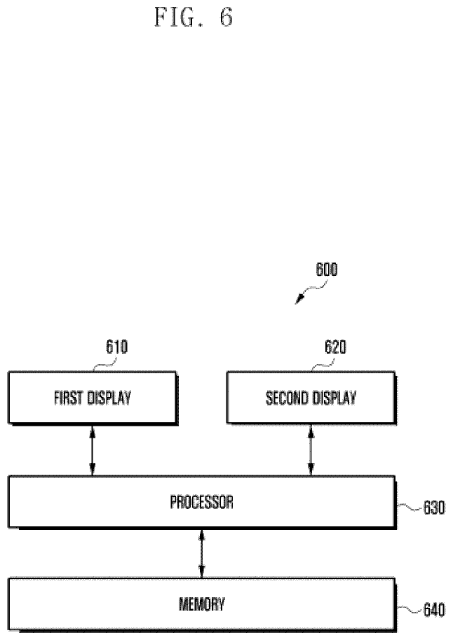

FIG. 6 is a block diagram of an electronic device according to certain embodiments.

Referring to FIG. 6, the electronic device 600 may include a first display 610, a second display 620, a processor 630, and memory 640, and some of the illustrated components may be omitted or replaced. The electronic device 600 may include at least some of the components and/or functions of the electronic device 101 of FIG. 1.

According to certain embodiments, the electronic device 600 may include the structures of FIGS. 2A, 2B, and 3, and may include a foldable structure described above with reference to FIGS. 4A to 4D. In addition, as described above with reference to FIG. 5, the electronic device 600 may include a structure (e.g., the recess 595 in FIG. 5A) for accommodating a stylus pen (e.g., the stylus pen 590 in FIG. 5B).

According to certain embodiments, the first display 610 may be disposed on a first face (or the front face) in a first direction of a housing (e.g., the housings 210 and 220 in FIG. 2A) of the electronic device 600. According to certain embodiments, the first display 610 is foldable. The first display 610 may be divided into a first region (e.g., the first region 231a in FIG. 2A) and a second region (e.g., the second region 231b in FIG. 2A) with reference to a folding region (e.g., the folding region 231c in FIG. 2A), and the first display 610 may be folded in a direction in which the first region and the second region face each other. Accordingly, the first display 610 may not be seen by the user in the state in which the electronic device 600 is folded.

According to certain embodiments, the second display 620 may be disposed on a second face (or the rear face) in a second direction of the housing of the electronic device 600. The second display 620 may be disposed on a face opposite the first region of the second face of the housing or a face opposite the second region of the second face of the housing. More specifically, the second display 620 may be disposed on one of the rear covers of the housing (e.g., the second rear cover 250 in FIG. 2A). Accordingly, the area (or the length in the lateral direction) of the second display 620 may be equal to or less than half of the area (or the length in the lateral direction) of the first display 610.

According to certain embodiments, each of the first display 610 and the second display 620 may include a touch sensor, and the touch sensor may be implemented in any of various types including an in-cell type and an on-cell type.

According to certain embodiments, the memory 640 is functionally, operatively and/or electrically connected to the processor 630, and may store various instructions that can be executed by the processor 630. Such instructions may include various control commands including arithmetic and logical operations, data movement, and input/output that can be recognized by the processor 630.

According to certain embodiments, the processor 630 is a component capable of performing an operation or data processing related to control and/or communication of each component of the electronic device 600, and may include at least some of the components and/or functions of the processor 120 of FIG. 1. The processor 630 may be functionally, operatively, and/or electrically connected to internal components of the electronic device 600 including the first display 610, the second display 620, and the memory 640.

The processor 630 will not be limited to the operation and data processing functions that can be implemented in the electronic device 600. However, in this document, a description will be made of certain embodiments, in which a content is generated according to user input on the second display 620 in the folded state of the second display 620 (or the electronic device 600) and the generated content is provided through the first display 610 when the first display 610 is unfolded.

Operations of the processor 630, which will be described later, may be performed by loading instructions stored in the memory 640.

According to certain embodiments, the processor 630 may provide various application screens through the second display 620 in the state in which the first display 610 is folded. For example, the processor 630 may turn off the second display 620 in the standby mode or may cause an always-on-display (AOD) screen to be displayed on the second display 620, and may then activate the second display 620 in response to touch input on the second display 620, input on a hard key, or an event generated in an application (e.g., call reception, SMS, push, or IM message reception) so as to display an application screen. In this case, the processor 630 may turn off the first display 610 and the touch sensors of the first display 610.

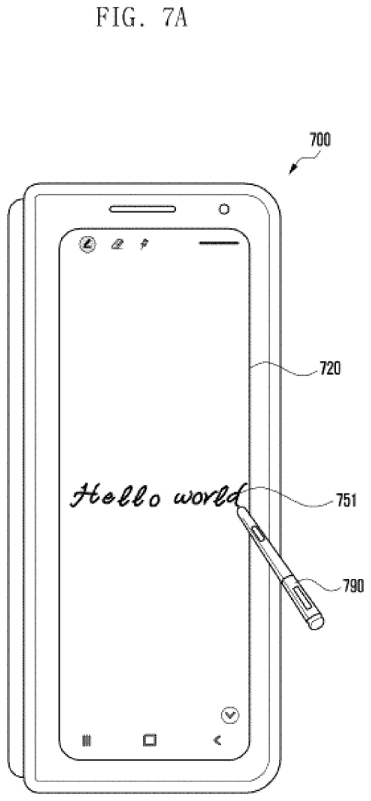

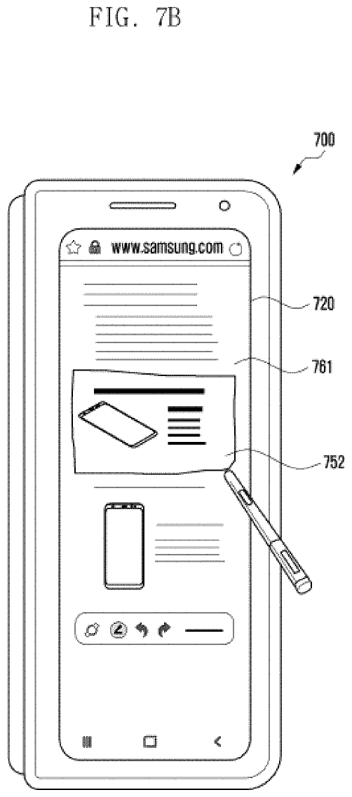

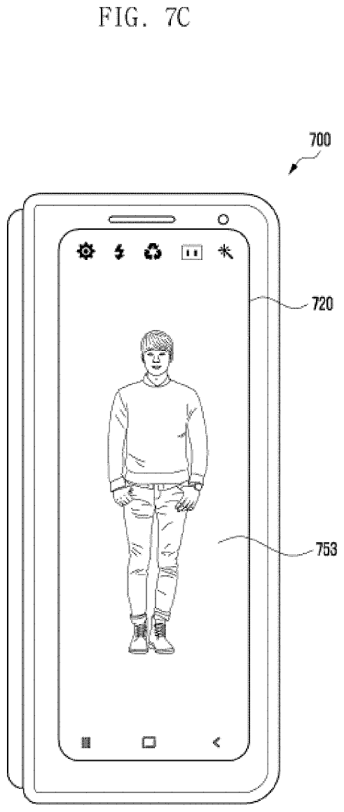

According to certain embodiments, the processor 630 may generate various contents when touch input or hovering input is performed on an application displayed on the second display 620. According to certain embodiments, the second display 620 may acquire a location of touch input or hovering input using a stylus pen, and may generate a content depending on the input location. According to certain embodiments, the content may include at least one of a memo, a captured image, and a cropped image. Examples of the contents generated depending on the user input on the second display 620 will be described later in detail with reference to FIGS. 7A to 7C.

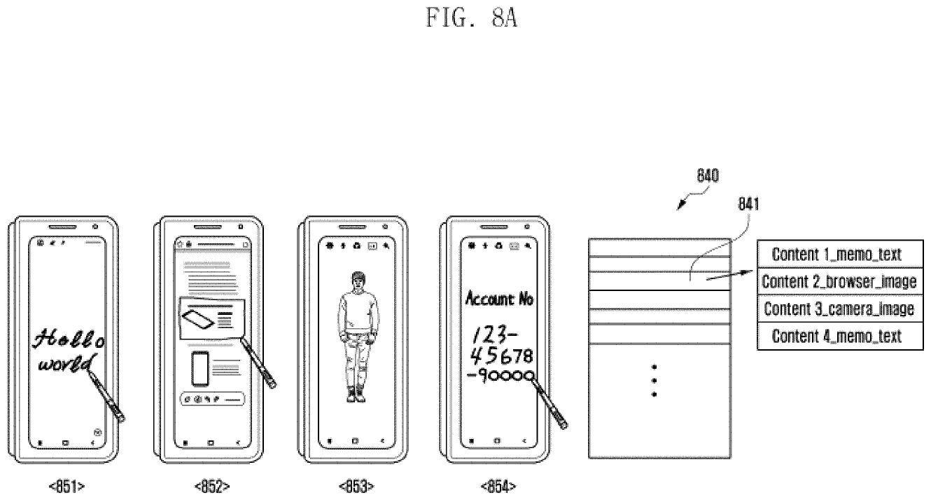

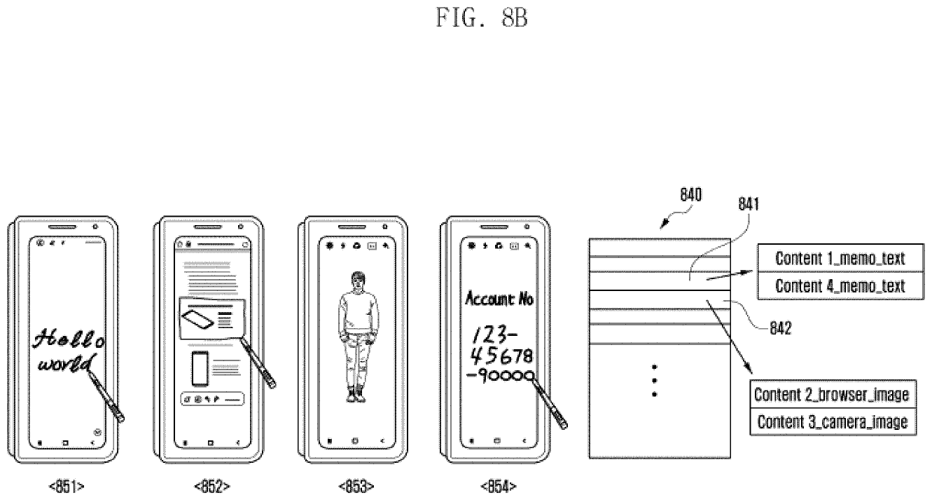

According to certain embodiments, the processor 630 may sequentially store contents generated by each application. In this case, the electronic device 600 may store at least one content generated by touch input on the second display 620 in a designated region of the memory 640. Here, the designated region may include an address of a specific folder, a directory, a clip board, or the memory 640, or the like. This will be described in detail with reference to FIGS. 8A and 8B.

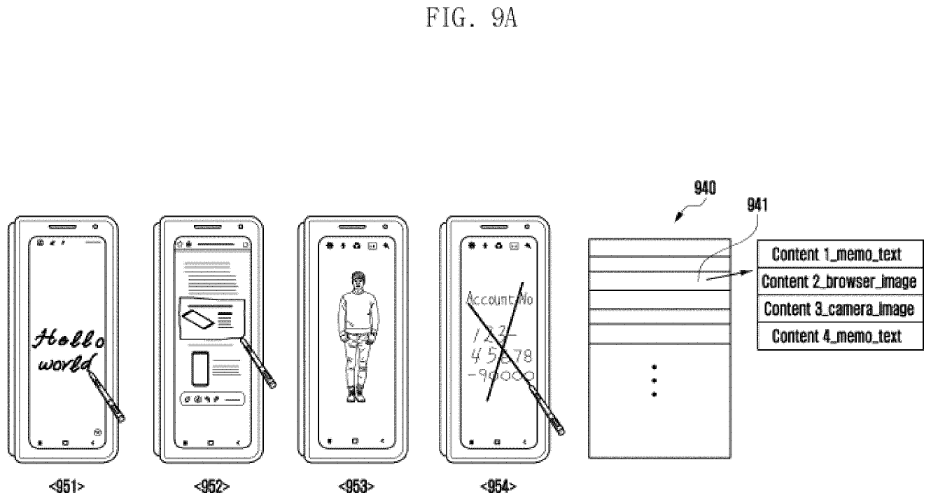

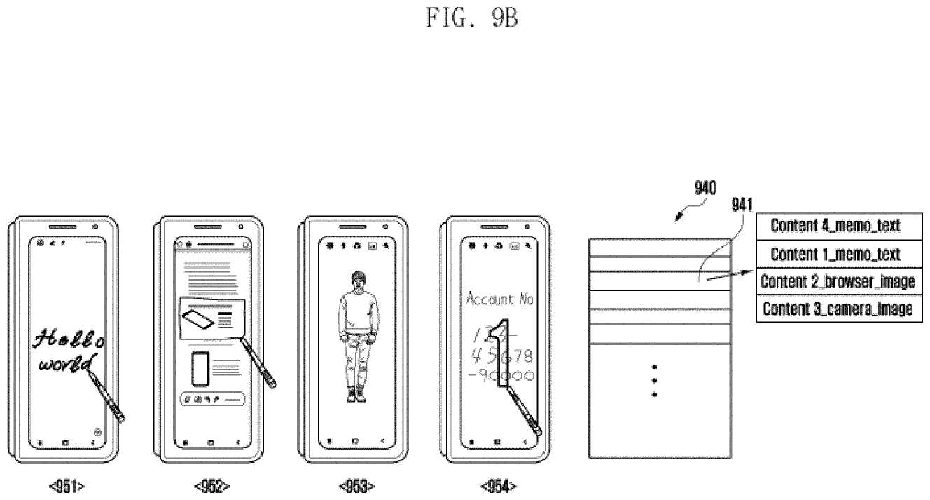

According to certain embodiments, the processor 630 may delete some of the generated contents or change a storage order of the contents in response to user input. This will be described in detail with reference to FIGS. 9A and 9B.

According to certain embodiments, the processor 630 may detect unfolding of the first display 610. When the angle formed by the first portion and the second portion divided based on the folding line of the first display 610 or the angle of the folded housing structures (e.g., the first housing structure 210 and the second housing structure 220 in FIG. 2) reaches a predetermined angle (e.g., 170 degrees), the processor 630 may determine that the first display 610 is unfolded. The electronic device 600 may include a sensor configured to detect the angle, and the processor 630 may receive a sensing value of the sensor to determine folding and/or unfolding of the first display 610.

When the first display 610 is unfolded, the processor 630 may enable the first display 610 and the touch sensor. In this case, the first display 610 may display a home screen or an application displayed before the first display 610 is folded (or before the first display 610 is turned off).

According to certain embodiments, in the state in which the first display 610 is unfolded, the processor 630 may display at least one graphic object corresponding to at least one generated content on at least a portion of the first display 610. Here, the content may be a content generated by user input on the second display 620 in the state in which the first display 610 is folded.

According to certain embodiments, the processor 630 may display a content dock including at least one graphic object on at least a portion of the first display 610. Here, the content dock is an area for displaying at least one graphic object corresponding to a generated content to be distinguished from a home screen or an application screen, and may be differently referred to as pop-up, tray, window, or the like.

According to certain embodiments, the processor 630 may arrange graphic objects from the top to the bottom (or vice versa) in the order in which respective contents are generated in the content dock, and may classify and display graphic objects according to the applications of the contents and/or the types of the contents (e.g., an image or text). The processor 630 may determine the display order of graphic objects according to a designated order on a designated region of the memory 640.

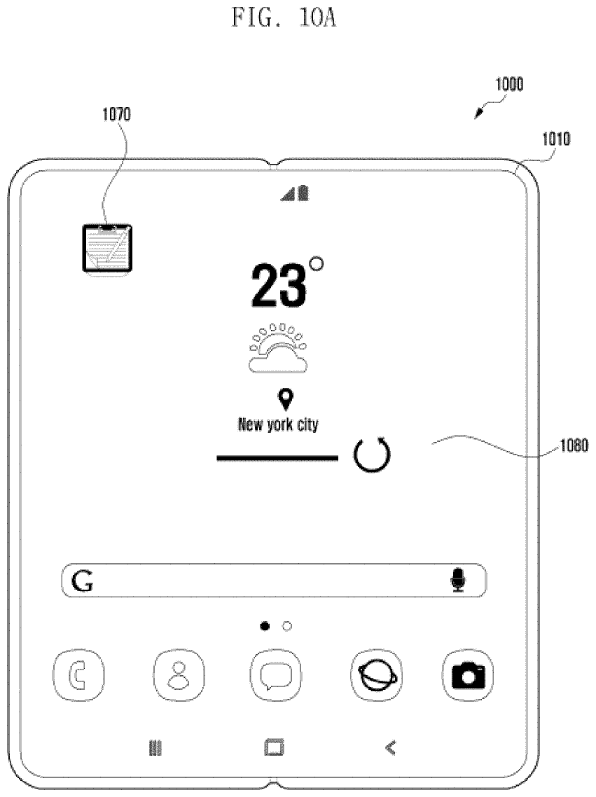

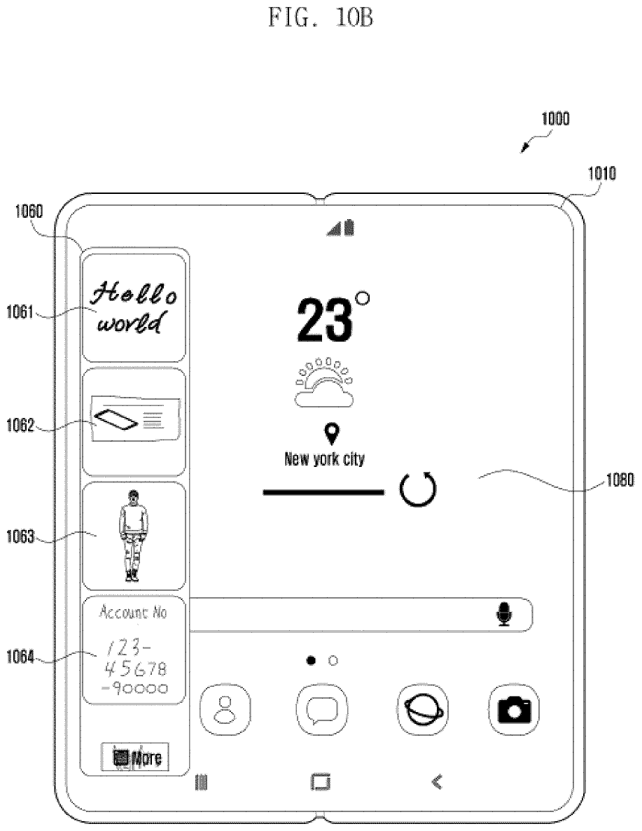

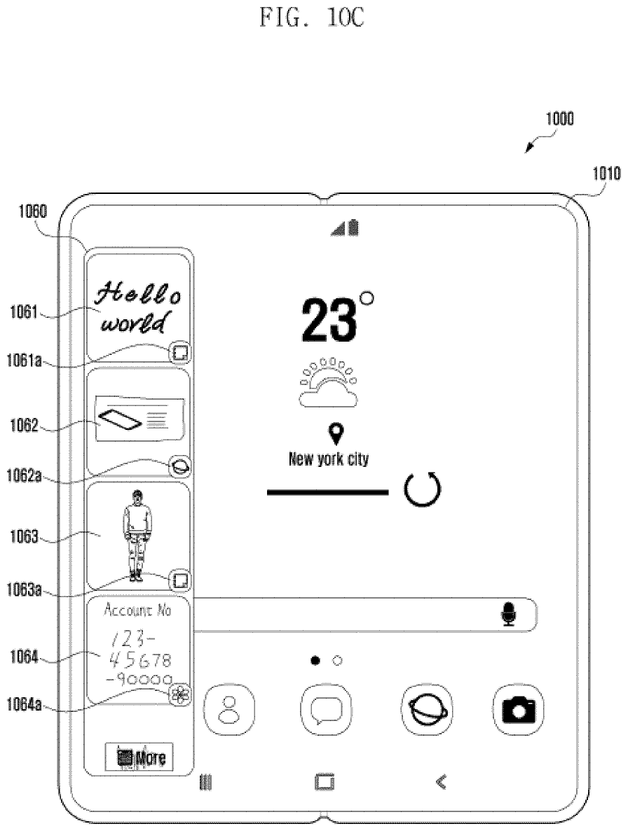

According to certain embodiments, the content dock may be visually distinguished from other icons (e.g., shortcut icons for a message or call) on the home screen, and the processor 630 may maintain the display of the content dock without relying on a change of a home screen (e.g., switching a home screen page or executing an application). To this end, the processor 630 may generate the content dock as a layer separate from the home screen or another application execution screen, and may display the content dock as a higher layer. A detailed example of the content dock will be described in detail with reference to FIG. 10B.

According to certain embodiments, when the unfolding of the first display 610 is detected, the processor 630 may display a floating icon corresponding thereto, and may display a content dock based on the input on the floating icon. This will be described in detail with reference to FIG. 10A. Unlike this, when the unfolding of the first display 610 is detected, the processor 630 may immediately display a content dock or directly display a content in response thereto.

According to certain embodiments, the processor 630 may identify whether the stylus pen is removed from the recess in the housing of the electronic device 600 in response to the unfolding of the first display 610, and when it is identified that the stylus pen is removed, the processor 630 may cause a floating icon and/or a content dock to be displayed. The present embodiment corresponds to one of certain embodiments, and the electronic device 600 may not include a stylus pen, or may display a graphic object when the first display 610 is unfolded even if the electronic device 600 includes a stylus pen.

According to certain embodiments, if there is no content generated in the folded state until the unfolding, the electronic device 600 may not display a graphic object.

According to certain embodiments, the processor 630 may cause at least one content corresponding to at least one selected graphic object to be displayed on the first display 610 in response to selection of at least one of one or more graphic objects of the content dock. At this time, the processor 630 may execute an application (e.g., a memo application or an image editing application) of the selected content, and may read out the content from the designated region in which the content is stored. The electronic device 600 may run in an editing mode in which the content can be edited directly.

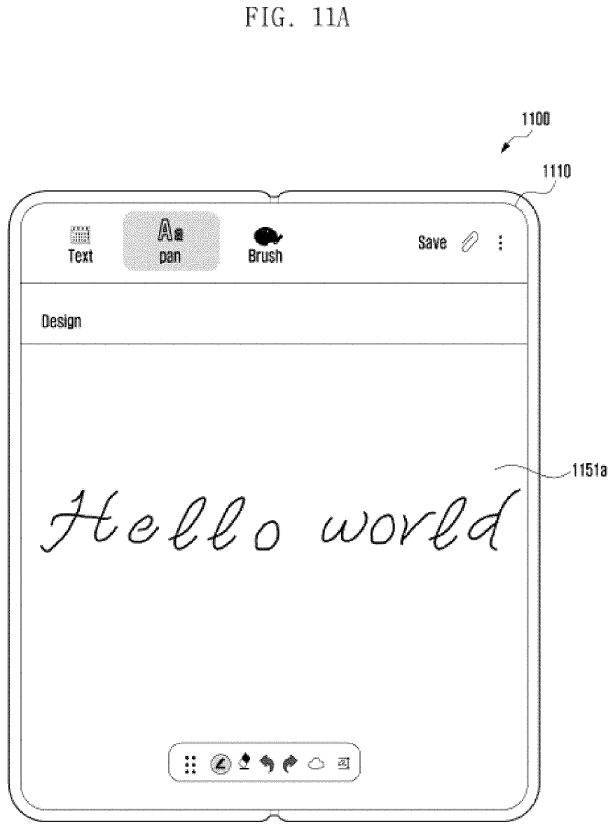

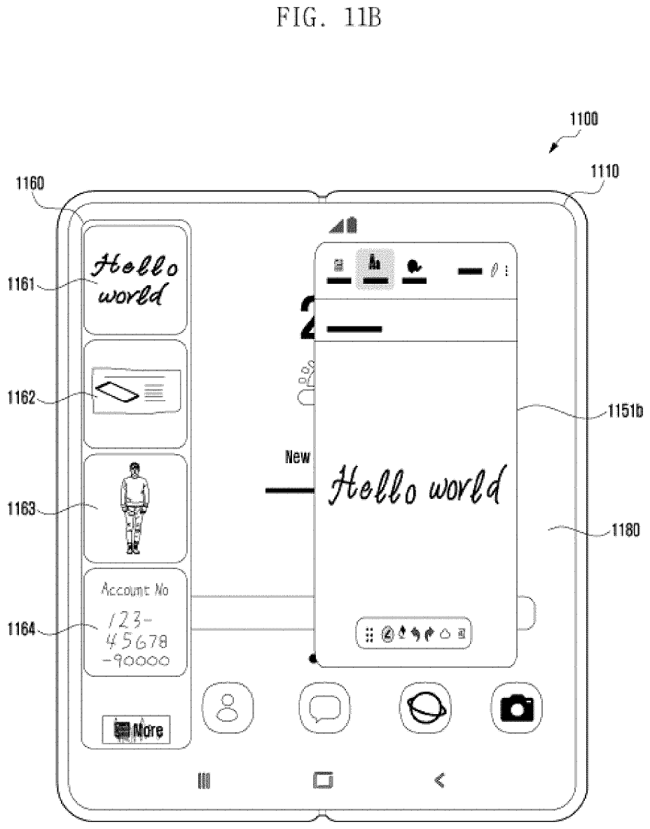

According to certain embodiments, the processor 630 may cause a content corresponding to a graphic object selected from the content dock to be displayed on the first display 610 as a full screen, pop up, or split screen. This will be described in detail with reference to FIGS. 11A to 11C.

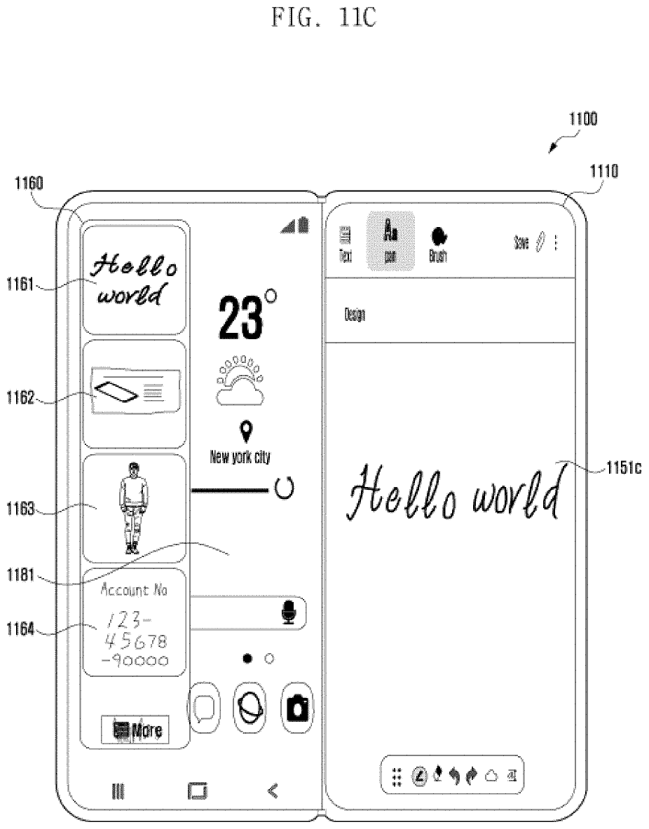

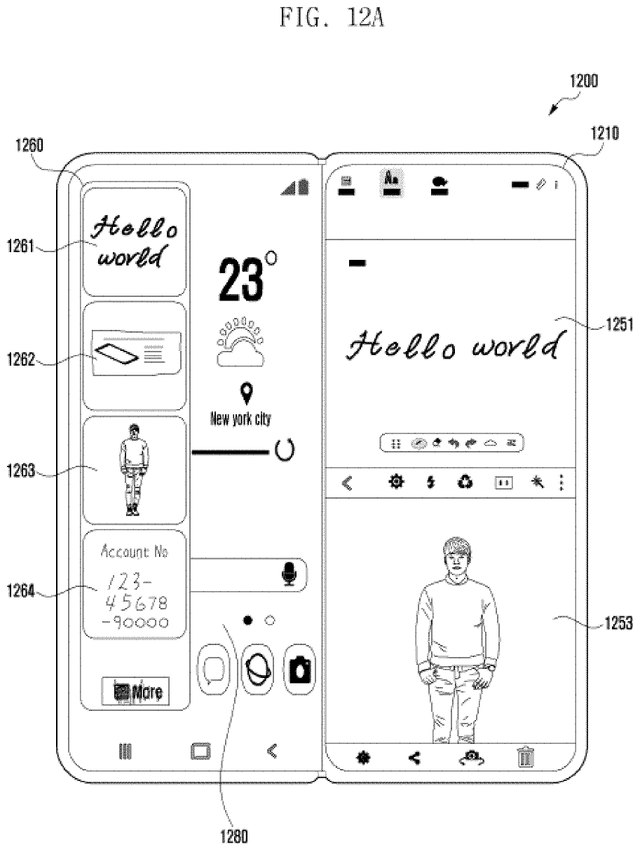

According to certain embodiments, when multiple graphic objects are simultaneously or sequentially selected from a content dock, the electronic device 600 may cause multiple contents corresponding to the selected multiple graphic objects to be displayed on the first display 610 in a multi-window. This will be described in detail with reference to FIGS. 12A to 12B.

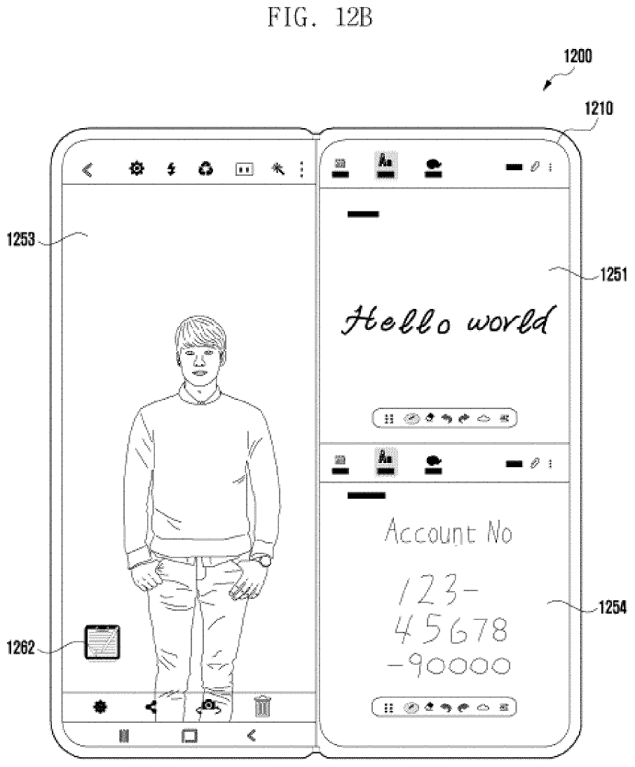

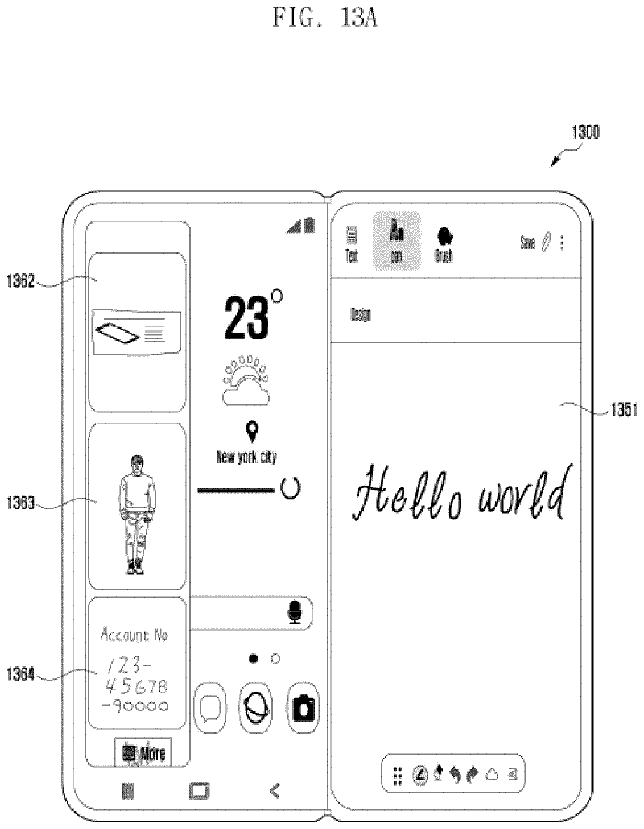

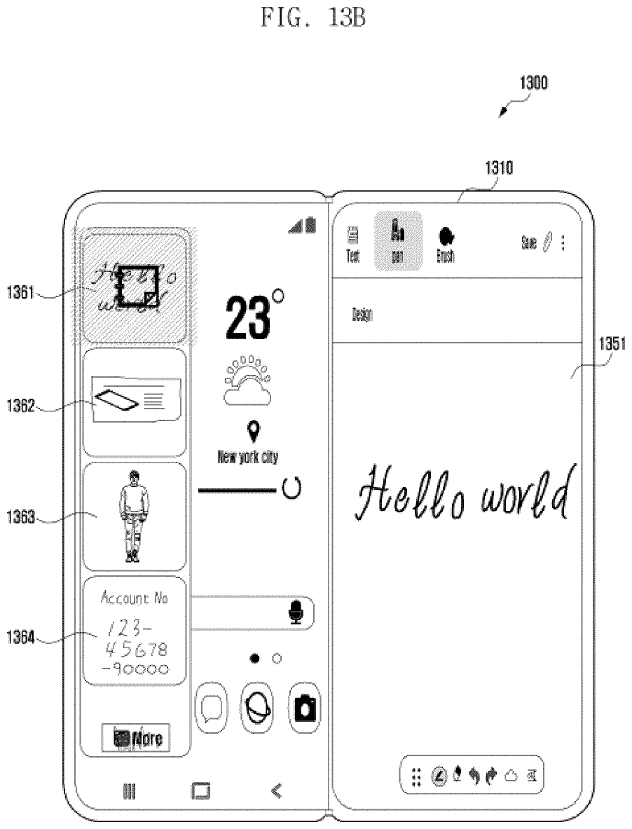

According to certain embodiments, the electronic device 600 may change the display such that a graphic object corresponding to the content displayed according to the user's selection among one or more graphic objects of the content dock is distinguished from other graphic objects. This will be described in detail with reference to FIGS. 13A to 13B.

A structure, in which the first region and the second region of the first display 610 face each other when the electronic device 600 is folded, that is, an in-folding structure in which the first display 610 is folded inward, has been described above. However, certain embodiments are not limited thereto.

According to certain embodiments, the electronic device 600 may be implemented as a structure in which the first region and the second region divided with reference to the folding line are exposed to the outside when the electronic device 600 is folded, that is, an out-folding structure in which the first display 610 is folded outward.

In this case, in the state in which the first display 610 is folded, the processor 630 may generate at least one content based on user input on the first display 610, and in the state in which the first display 610 is unfolded, the processor may cause a graphic object corresponding to the at least one generated content to be displayed on at least a portion of the first display 610.

FIG. 7A illustrates an example of a content generated in a folded state according to certain embodiments, FIG. 7B illustrates an example of a content generated in a folded state according to certain embodiments, and FIG. 7C illustrates an example of a content generated in a folded state according to certain embodiments.

According to certain embodiments, in the state in which a first display (e.g., the first display 610 in FIG. 6) is in the folded state, the electronic device 700 may generate at least one content based on user input on a second display 720 (e.g., the second display 620 in FIG. 6).

According to certain embodiments, in the state in which the first display is folded, the electronic device 700 may selectively turn off the first display. At this time, the electronic device 700 may display various applications using the display 720. For example, in a sleep mode, the second display 720 may be turned off or an always-on-display (AOD) screen may be displayed. Thereafter, in response to touch input on the second display 720, input on a hard key, or an event generated in an application (e.g., call reception, SMS, push, or IM message reception), the second display 720 may be activated such that an application screen can be displayed thereon.

A user may generate various contents by performing touch input or hovering input on an application displayed on the second display 720. According to certain embodiments, the second display 720 may acquire a location of touch input or hovering input using a stylus pen, and may generate a content depending on the input location. According to certain embodiments, the content may include at least one of a memo, a captured image, and a cropped image.

Referring to FIG. 7A, the electronic device 700 may display a memo application 751 on the second display 720 in the folded state. At this time, the memo application may be executed in response to selection (e.g., touch selection) of a memo application icon in the home screen displayed on the second display 720, and when the stylus pen 790 is removed from the recess of the electronic device 700, the memo application may be executed, even if there is no additional input on the second display 720. When the memo application is executed, the user may generate memo data by inputting characters using a keyboard or using handwritten input.

Referring to FIG. 7B, in the state in which various applications 761, such as a web browser and a game, are displayed on the second display 720, the electronic device 700 may capture an image or may crop a portion 752 of the image in response to a touch input, such as drawing a boundary around a section to be cropped, using the stylus.

Referring to FIG. 7C, an image editing application 753 (e.g., a gallery application) may be displayed on the second display 720, and the electronic device 700 may permit editing of an image using touch input commands (e.g., editing of the size, rotation, color, or resolution of an image).

According to certain embodiments, the electronic device 700 may sequentially store contents generated by each application. In this case, the electronic device 700 may store at least one content generated by touch input on the second display 720 in a designated region of memory (e.g., the memory 640 in FIG. 6).

FIGS. 7A to 7C illustrate applications that can be provided through the second display 720 and contents that can be generated according to user input. However, the applications and contents are merely examples, and this disclosure is not limited thereto.

FIG. 8A illustrates a method of storing contents generated in a folded state according to certain embodiments, and FIG. 8B illustrates a method of storing contents generated in a folded state according to certain embodiments.

According to certain embodiments, the electronic device 800 may store a content, generated based on user input (e.g., touch input or hovering input using a stylus pen) on a second display (e.g., the second display 620 of FIG. 6), in memory 840. At this time, the electronic device 800 may store the at least one content in a designated region 841 in the memory 840, until the first display (e.g., the first display 610 in FIG. 6) is folded and then unfolded again.

Here, the designated region 841 in the memory 840 may include an address of a specific folder, a directory, a clip board, or the memory, or the like. The designated region 841 is a temporary storage space, which may be generated when the first display is folded and may be deleted when the first display is unfolded again.

Referring to FIG. 8A, for example, the user may sequentially generate a first content 851 (or a memo content) including a handwriting input on the memo application, a second content 852 (or an image-cropped content) generated by cropping a partial region of a web browser, a third content 853 (or an image-edited content) generated by editing an image acquired by a camera application, and a fourth content 854 (or a memo content) generated by another handwriting input on the memo application. At this time, the electronic device 800 may sequentially store the first to fourth contents 851, 852, 853, and 854 in the designated region 841 of the memory 840.

According to certain embodiments, the electronic device 800 may classify and store one or more contents, acquired in the folded state, by category. Referring to FIG. 8B, among the generated first to fourth content 851, 852, 853, and 854, the first content 851 and the fourth content 854 may be text-based, and the second content 852 and the third content 853 may be image-based. In this case, the electronic device 800 may store the first content 851 and the fourth content 854, which are classified as a text category, in a first region 841 of the memory 840, and may store the second content 852 and the third content 853, which are classified as an image category, in the second region 842 of the memory 840.

FIG. 9A illustrates a method of editing a content storage space according to certain embodiments, and FIG. 9B illustrates a method of editing a content storage space according to certain embodiments.

According to certain embodiments, the electronic device 900 may sequentially generate contents 951, 952, 953, and 954, and then delete some contents in response to a predetermined input on the second display. Referring to FIG. 9A, after a user generates the first to fourth contents 951, 952, 953, and 954, when a predetermined type of gesture (e.g., indicating an “X” symbol by drawing) is input in the state while the memo application of the fourth content 954 is displayed, the fourth content 954 may be deleted. In this case, information related to the fourth content 954 may be deleted from a predetermined region 941 of the memory 940 in which the first to fourth contents 951, 952, 953, and 954 are stored.

According to certain embodiments, the electronic device 900 may change the storage order of contents according to predetermined user input. Referring to FIG. 9B, in the state in which the first to fourth contents 951, 952, 953, and 954 are sequentially generated and stored, when the user inputs a predetermined type of gesture (e.g., drawing a “1” over the information) within a predetermined time after the generation of the fourth content 954, the storage order may be changed such that the fourth content 954 is changed to a first storage position.

FIG. 10A illustrates a screen displayed when an electronic device according to certain embodiments is unfolded, FIG. 10B illustrates a screen displayed when an electronic device according to certain embodiments is unfolded, and FIG. 10C illustrates a screen displayed when an electronic device according to certain embodiments is unfolded.

According to certain embodiments, when a first display (e.g., the first display 610 in FIG. 6) is unfolded, an electronic device 1000 (e.g., the electronic device 600 in FIG. 6) may activate the first display, and may display, on the first display, a home screen 1080 or an application screen, which has been displayed before the first display is folded. When the angle formed by a first portion and a second portion divided based on the folding line of the first display or the angle of folded housing structures (e.g., the first housing structure 210 and the second housing structure 220 in FIG. 2) reaches a predetermined angle (e.g., 170 degrees), the electronic device 1000 may determine that the first display is unfolded.

According to certain embodiments, the electronic device 1000 may display a floating icon 1070 on the first display in response to detection of the unfolding of the first display.

Referring to FIG. 10A, the floating icon 1070 may be displayed in a partial region (e.g., the upper left) of the first display 1010. The floating icon 1070 may be visually distinguished from other icons of the home screen 1080 (e.g., shortcut icons of message, call, and the like on the home screen 1080) for, for example, some display characteristic, such as highlighting, a border, a special icon, etc., or may be displayed as it is, without relying on the change of the home screen 1080 (e.g., switching of the home screen page or execution of an application). To this end, the electronic device 1000 may generate the floating icon 1070 as a layer separate from the home screen 1080 or another application execution screen, and may display the floating icon 1070 as a higher layer. The floating icon 1070 may be moved in response to touch and drag.

According to certain embodiments, in response to the unfolding of the first display, the electronic device 1000 may identify whether a stylus pen (e.g., the stylus pen 590 in FIG. 5B) is removed from a recess (e.g., the recess 595 in FIG. 5A) in the housing of the electronic device 1000, and when it is identified that the stylus pen is removed, the electronic device 1000 may display the floating icon 1070. When the first display is unfolded while the stylus pen is removed, a user may intend to continue editing of content that began in the folded state, and now should continue that editing in the unfolded state of the first display. The present embodiment corresponds to one of certain embodiments, and it is understood in other embodiments the electronic device 1000 may not include a stylus pen, or may display a graphic object when the first display is unfolded even if the electronic device 1000 includes a stylus pen.

According to certain embodiments, if there is no content generated in the folded state until the unfolding, the electronic device 1000 may not display a graphic object.

According to certain embodiments, in response to detection of the unfolding of the first display, the electronic device 1000 may directly display the content dock 1060 of FIG. 10B, which will be described later, without displaying the floating icon 1070 of FIG. 10A. In this case, when the first display is unfolded, the electronic device 1000 may determine whether to display the content dock 1060 by identifying whether the stylus pen is removed and whether a content is generated in the folded state. Alternatively, the electronic device 1000 may directly display the previously generated contents as a multi-window in response to detection of the unfolding of the first display without displaying the floating icon 1070 and the content dock 1060.

According to certain embodiments, in response to selection of the floating icon 1070, the electronic device 1000 may display at least one graphic object corresponding to at least one previously generated content on the first display. Here, the contents may be contents generated by input on the second display in the state in which the first display is folded (e.g., the memo content in FIG. 7A, the image-cropped content in FIG. 7B, and the image-edited content in FIG. 7C). The graphic object may include a thumbnail of each content, and at least a part other than information utilized to recognize each content may be excluded from the thumbnail.

According to certain embodiments, a content dock 1060 including at least one graphic object may be displayed on at least a portion of the first display. Here, the content dock 1060 is an area for displaying at least one graphic object corresponding to a generated content to be distinguished from a home screen 1080 or an application screen, and may be differently referred to as pop-up, tray, window, or the like. Referring to FIGS. 10A to 10C, the content dock 1060 may include a first graphic object 1061, a second graphic object 1062, a third graphic object 1063, and a fourth graphic object 1064, which correspond to a first content (or a memo content), a second content (or an image-cropped content), a third content (or an image-edited content), and a fourth content (or a memo content), which are generated by user input on the second display in the folded state.

According to certain embodiments, in response to an event for triggering display of the content dock 1060 (e.g., selection of the floating icon 1070 or unfolding of the first display), the electronic device 1000 may identify contents stored in a designated region (e.g., a folder) of memory, and may generate a content dock 1060 including the graphic objects 1061, 1062, 1063, and 1064 corresponding to respective contents. In the content dock 1060, graphic objects 1061, 1062, 1063, and 1064 may be displayed from top to bottom (or vice versa) in the order in which respective contents are generated, and graphic objects 1061, 1062, 1063, and 1064 may be classified and displayed based on applications of contents and/or types of contents (e.g., image or text). The electronic device 1000 may determine the display order of the graphic objects according to a designated order on a designated region (e.g., the designated region 941 in FIG. 9A) of the memory (e.g., the memory 940 in FIG. 9A) (considering that the order is changed as illustrated in FIG. 9, as well).

Referring to FIG. 10B, the first to fourth graphic objects 1061, 1062, 1063, and 1064, which correspond to thumbnails of the first to fourth contents sequentially generated in the folded state, may be displayed in the content dock 1060 in order. The content dock 1060 may be visually distinguished from other icons of the home screen 1080 (e.g., shortcut icons of message, call, and the like), and may be displayed as it is, without relying on the change of the home screen 1080 (e.g., switching of the home screen 1080 page or execution of an application). To this end, the electronic device 1000 may generate the content dock 1060 as a layer separate from the home screen 1080 or another application execution screen, and may display the content dock 1060 as a higher layer. The content dock 1060 may be moved in response to touch and drag.

According to another embodiment, the electronic device 1000 may partially reduce the size of the home screen 1080 (or an application screen), and may display the content dock 1060 in a multi-window on the reduced region.

When the number of graphic objects is large and thus it is difficult to display all of the graphic objects in the content dock 1060, several graphic objects may be displayed and some of them may be hidden in the order in which the contents are generated. In this case, the content dock 1060 may support scrolling so that a graphic object of a lower priority can be displayed according to the scrolling.

According to certain embodiments, the electronic device 1000 may be implemented in a vertical folding type in which the upper face and the lower face of the electronic device 1000 meet when the electronic device 1000 is folded. In this case, the content duck may be displayed on the upper portion or the lower portion of the first display when the first display is unfolded, and graphic objects in the content dock may be sequentially displayed in the horizontal direction.

Referring to FIG. 10C, respective graphic object displayed on the content dock 1060 may display icons 1061a, 1062a, 1063a, and 1064a corresponding to the applications in which the respective contents are generated. Here, the icons 1061a, 1062a, 1063a, and 1064a may have shapes or images displayed therein, which are the same or similar to those of the application icons on the home screen 1080 as to allow easy identification of a corresponding application. Alternatively, at least one of the graphic objects 1061, 1062, 1063, and 1064 may further include information related to the content, such as the name and creation time of a content designated by the user.

According to certain embodiments, after the content dock 1060 is displayed, when no graphic object is selected for a predetermined length of time or when an application that generates a graphic object of the content dock 1060 is executed due to input on an icon on the home screen 1080, the display of the content dock 1060 may be removed.

FIG. 11A illustrates a method of displaying a content in the state in which an electronic device according to certain embodiments is unfolded, FIG. 11B illustrates a method of displaying a content in the state in which an electronic device according to certain embodiments is unfolded, and FIG. 11C illustrates a method of displaying a content in the state in which an electronic device according to certain embodiments is unfolded.

According to certain embodiments, in response to selection of at least one of one or more graphic objects (e.g., the graphic objects 1061, 1062, 1063, and 1064 in FIG. 10B) of the content dock (e.g., the content dock 1060 in FIG. 10B), the electronic device 1100 may display at least one content corresponding to the at least one selected graphic object on the first display 1110.

According to certain embodiments, the electronic device 1100 may execute an application (e.g., a memo application or an image editing application) of the selected content, and may read out the content from the designated region in which the content is stored. The electronic device 1100 may run in an editing mode in which the content can be edited directly.

The user may sequentially or simultaneously select multiple graphic objects in the content dock. For example, the user may sequentially select two or more of the graphic objects of the content dock by touch input, or may select two or more graphic objects simultaneously by multi-touch.

According to certain embodiments, the electronic device 1100 may display a content corresponding to a selected graphic object on the first display 1110.

Referring to FIG. 11A, the electronic device 1100 may display a first content 1151a (e.g., a memo) corresponding to a selected first graphic object on the entire screen of the first display 1110. Here, the content 1151a displayed on the entire screen may be the same as the screen when the memo application is executed on the home screen, and the content dock may be removed or may be displayed on a lower layer of the content.

Referring to FIG. 11B, the electronic device 1100 may display a content corresponding to a selected graphic object as a pop-up window 1151b. At this time, the pop-up window may be displayed on an upper layer of the home screen 1180 (or an application screen), and the display of the content dock 1160 may be maintained, including display objects 1161, 1162, 1163, and 1164.

Referring to FIG. 11C, the electronic device 1100 may display a content 1151c corresponding to a selected graphic object as a home screen 1181 or an application screen and a split screen. As illustrated, the content 1151c and the home screen 1181 may be displayed as split screens, and thus the home screen 1181 may be scaled in the lateral direction.

FIG. 12A illustrates a method of displaying multiple contents together in the state in which an electronic device 1200 according to certain embodiments is unfolded, and FIG. 12B illustrates a method of displaying multiple contents together in the state in which an electronic device 1200 according to certain embodiments is unfolded.

According to certain embodiments, when multiple graphic objects are simultaneously or sequentially selected from a content dock 1260, the electronic device 1200 may cause multiple contents corresponding to the selected multiple graphic objects to be displayed on the first display 1210 as a multi-window.

Referring to FIG. 12A, when the user sequentially selects a first graphic object 1261 (or a graphic object of a memo content) and a third graphic object 1263 (or a graphic object of an image-edited content) from the content dock 1260 or simultaneously selects by multi-touch, the electronic device 1200 may displays a first content 1251 corresponding to the first graphic object 1261 and a third content 1253 corresponding to the third graphic object 1263 in a region of the first display 1210 in the form of a multi-window. A fourth object 1264 may also be displayed.

At this time, the home screen 1280 may also be partially scaled in the lateral direction, and the content dock 1260 may remain displayed.

Referring to FIG. 12B, thereafter, when a second graphic object 1262 (or a graphic object of an image-cropped content) is additionally selected, the electronic device 1200 may display the first content 1251, the second content 1252, and the third content 1253 in a multi-window. At this time, when a space for displaying the contents is insufficient on the first display 1210 (e.g., when three or more contents are displayed simultaneously), the display of the content dock 1260 may be removed, and a floating icon may be displayed. Thereafter, when the user selects the floating icon, the content dock 1260 may be displayed on an upper layer of the contents displayed in the multi-window.

FIG. 13A illustrates a method of displaying on display 1310 a content dock in the state in which an electronic device according to certain embodiments is unfolded, and FIG. 13B illustrates a method of displaying a content dock in the state in which an electronic device according to certain embodiments is unfolded.

According to certain embodiments, the electronic device 1300 may change the display such that a graphic object corresponding to a content displayed according to the user's selection among one or more graphic objects 1362, 1363, and 1364 of the content dock 1360 is distinguished from other graphic objects.

Referring to FIG. 13A, when a first content 1351 (a memo) is displayed in response to selection of a first graphic object, the first graphic object of the content dock 1360 may be removed from the content dock 1360. Thereafter, when edition of the first content 1351 is completed and the memo application is terminated, the first graphic object may be displayed again in the content dock 1360.

Referring to FIG. 13B, when the first content 1351 (a memo) is displayed in response to selection of the first graphic object, the first graphic object 1361 of the content dock 1360 may be provided with a visual effect so as to be distinguished from other graphic objects. For example, the visual effect may be, for example, a shadow, color or other shading effect, and an application icon of the corresponding content may be displayed on a visually distinguished thumbnail.

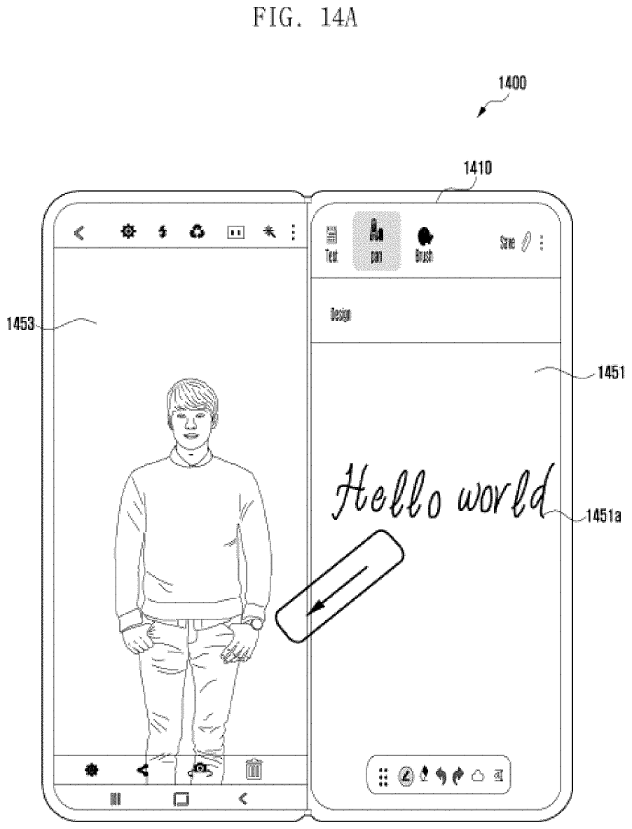

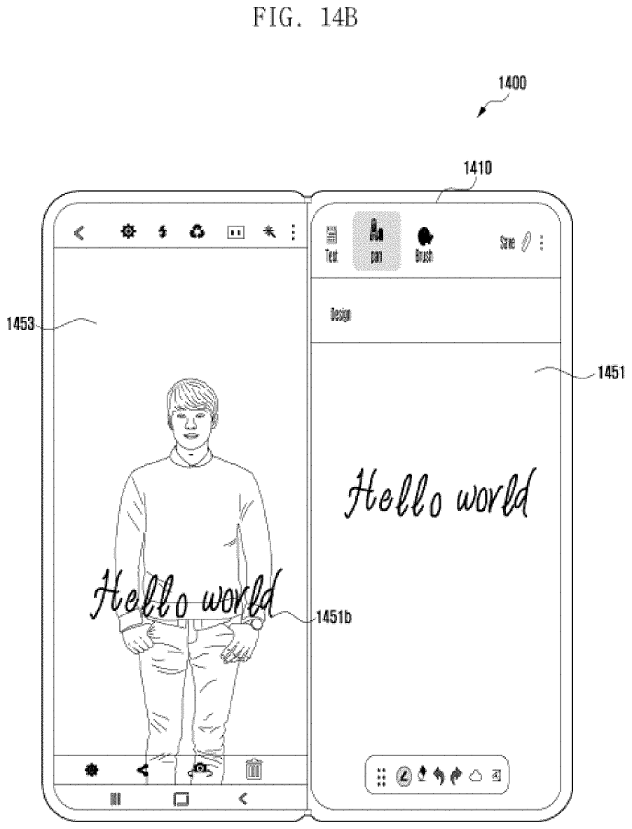

FIG. 14A is a view illustrating a method of editing a content according to certain embodiments, and FIG. 14B is a view illustrating a method of editing a content according to certain embodiments.

According to certain embodiments, when multiple contents are displayed on the first display, the electronic device 1400 may provide a function of editing other contents using data of one of the contents. Here, the editing may include copying, moving, and the like.

Referring to FIGS. 14A and 14B, in response to selection of a graphic object of a content dock displayed on display 1410, a first content 1451 (a memo) and a third content 1453 (an edited image) may be displayed in a multi-window. The user may select a portion including text 1451a of the first content and move the portion to a region 1451b of the third content 1453 through drag and drop. Accordingly, some text 1451a selected from the first content may be copied to the third content 1453 and the third content 1453 may be edited.

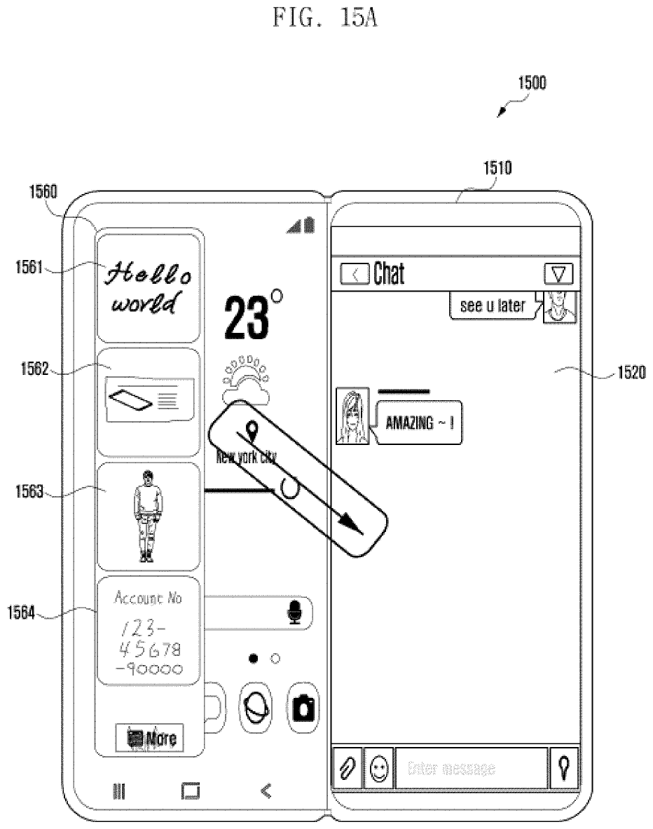

FIG. 15A is a view illustrating a method of editing a content according to certain embodiments, and FIG. 15B is a view illustrating a method of editing a content according to certain embodiments.

According to certain embodiments, an electronic device 1500 may provide a function of providing a content to other applications based on input on a graphic objects 1561, 1562, 1563, and 1564 of a content dock 1560 displayed on a display 1510.

Referring to FIGS. 15A and 15B, in the state in which the content dock 1560 is displayed, a message application 1520 may be displayed in response to user input. The user may select a second graphic object 1562 of the content dock 1560, and move the second graphic object 1562 onto the message application 1520 by dragging and dropping. In this case, a second content (e.g., a cropped image) corresponding to the second graphic object 1562 may be inserted into the message application 1520 and displayed as a message 1562a.

Although FIGS. 7A to 15B illustrate certain embodiments in which an electronic device includes an in-folding type display in which the first face and the second face of the first display face each other when the electronic device is folded, certain embodiments disclosed herein are not limited thereto.

For example, the electronic device may include an out-folding type foldable display in which the first face and the second face of the first display are exposed to the outside when the electronic device is folded. In this case, the electronic device may generate at least one content based on user input on one face (e.g., the first face or the second face) of the display in the folded state. Thereafter, when the display is unfolded, at least one graphic object corresponding to the at least one content generated in the folded state may be displayed on at least a portion of the unfolded display. The operation of displaying a floating icon, a content dock and a graphic object, and a content in the unfolded state may be the same as described with reference to FIGS. 7 to 15.

An electronic device according to certain embodiments may include: a housing; a first display disposed on a first face of the housing and configured to be foldable; a second display disposed on at least a portion of a second face of the housing; memory; and a processor operatively connected to the first display, the second display, and the memory. The memory may include instructions that, when executed, cause the processor to: generate at least one content based on user input on the second display in a state in which the first display is folded; detect unfolding of the first display; and cause at least one graphic object corresponding to the at least one generated content to be displayed in at least a portion of the first display in a state in which the first display is unfolded.

According to certain embodiments, the instructions may include instructions that cause the processor to: generate the at least one content based on user input on the second display, received before the first display is switched from the folded state to the unfolded state; and cause the at least one generated content to be stored in the memory.

According to certain embodiments, the instructions may include instructions that cause the processor to store the at least one generated content in the memory.

According to certain embodiments, the instructions may include instructions that cause the processor to: generate a first content based on user input on a first application displayed on the first display; and generate a second content based on user input on a second application displayed on the first display.

According to certain embodiments, the user input may include touch input or hovering input performed by a stylus pen.

According to certain embodiments, the housing may include a recess into which the stylus pen is removably insertable, and the instructions may include instructions that cause the processor to: identify whether the stylus pen is removed from the recess in response to the unfolding of the first display; and display the at least one graphic object on at least a portion of the first display when the stylus pen is removed.

According to certain embodiments, the instructions may include instructions that cause the processor to display a content dock including the at least one graphic object on at least a portion of the first display.

According to certain embodiments, the instructions may include instructions that cause the processor to display, when at least one graphic object is selected among one or more graphic objects of the content dock, at least one content corresponding to the at least one selected graphic object on the first display.

According to certain embodiments, the instructions may include instructions that cause the processor to display, when the multiple graphic objects are simultaneously or sequentially selected from the content dock, multiple contents corresponding to the selected multiple graphic objects on the first display in a multi-window.

According to certain embodiments, the instructions may include instructions that cause the processor to: display a floating icon on the first display in response to detection of the unfolding of the first display; and display the content dock in response to selection of the floating icon.

According to certain embodiments, in the state in which the first display may be folded, a first region and a second region of the first display divided with reference to a folding line are arranged to face each other, and the second display may be disposed on a face opposite the first region of the second face of the housing or a face opposite the second region of the second face.

According to certain embodiments, the content may include at least one of a memo, a captured image, and a cropped image.

An electronic device according to certain embodiments may include: a housing; a display disposed on one face of the housing and configured to be foldable; memory; and a processor operatively connected to the display and the memory. The memory may include instructions that, when executed, cause the processor to: generate at least one content based on user input on the display in a state in which the display is folded;

detect unfolding of the display; and display at least one graphic object corresponding to the at least one generated content on at least a portion of the display in a state in which the display is unfolded.

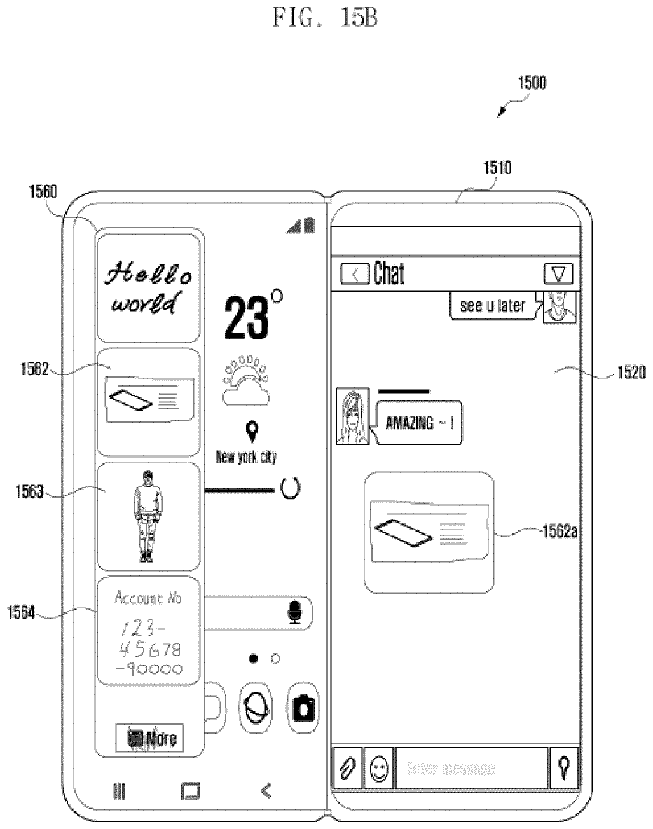

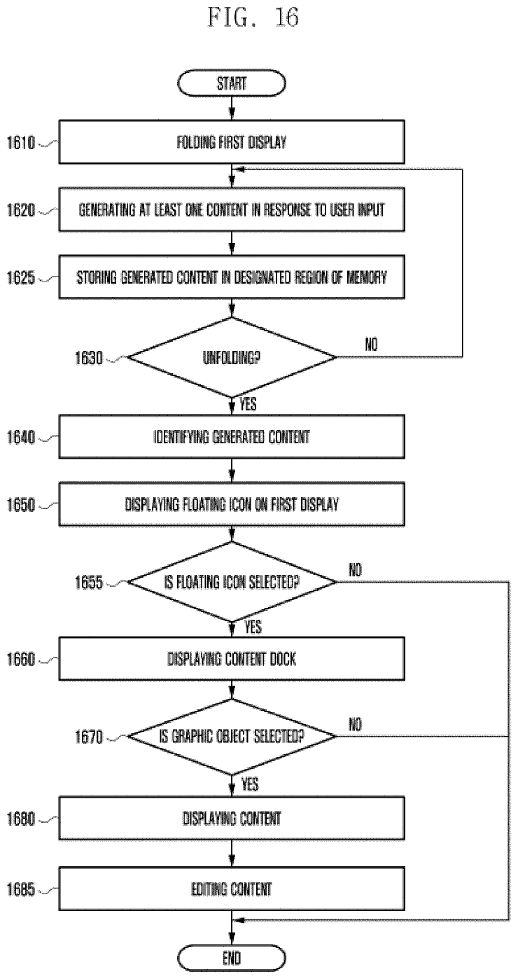

FIG. 16 is a flowchart illustrating a method of generating a content of an electronic device according to certain embodiments.

The illustrated method may be performed by the electronic device described with reference to FIGS. 1 to 15, and the description of the technical features described above will be omitted below.

According to certain embodiments, in operation 1610, the electronic device (e.g., the electronic device 600 of FIG. 6) may display various applications on the second display (e.g., the second display 620 in FIG. 6) while the first display (e.g., the first display 610 in FIG. 6) is in the folded state. According to certain embodiments, the first display may be of an in-folding type, that is, the type in which, when the first display is folded, the first region and the second region of the first display, which are divided with reference to the folding line, are arranged to face each other. According to other embodiments, the first display may be of an out-folding type, that is, the type in which, when the first display is folded, the first region and the second region are exposed to the outside and are disposed on different faces.

According to certain embodiments, in operation 1620, the electronic device (e.g., the processor 630 in FIG. 6) may generate at least one content based on user input on the second display in which the first display is disposed in the folded state. When folded, the second display may be disposed on a face opposite the first region of the second face of the housing, or a face opposite the second region of the second face of the housing.

The electronic device may generate various contents by touch input or hovering input performed on an application displayed on the second display. According to certain embodiments, the second display may acquire a location of touch input or hovering input using a stylus pen, and may generate a content depending on the input location. According to certain embodiments, the content may include at least one of a memo, a captured image, and a cropped image.

According to certain embodiments, in operation 1625, the electronic device may store the at least one generated content in a designated region of memory. Here, the designated region may include an address of a specific folder, a directory, a clip board, or the memory, or the like. According to certain embodiments, the electronic device may sequentially store contents generated by each application. According to certain embodiments, the electronic device may delete some of the generated contents or change a storage order of the contents in response to user input.

According to certain embodiments, in operation 1630, the electronic device may detect unfolding of the first display. When the angle formed by a first portion and a second portion divided based on the folding line of the first display or the angle of folded housing structures (e.g., the first housing structure 210 and the second housing structure 220 in FIG. 2) reaches a predetermined angle (e.g., 170 degrees), the electronic device may determine that the first display is unfolded.

According to certain embodiments, in operation 1640, the electronic device may identify a content previously generated in the designated region in the first display. Here, the content may be a content generated by user input on the second display while the first display is folded.

According to certain embodiments, in operation 1650, when the unfolding of the first display is detected and such generated content is present, the electronic device may display a floating icon on the first display.

According to certain embodiments, in operation 1655, the electronic device may receive an input selecting the floating icon. When the input selecting the floating icon is not received within a predetermined length of time, the electronic device may terminate display of the floating icon.

According to certain embodiments, when the input selecting the floating icon is received, in operation 1660, the electronic device may display a content dock including at least one graphic object on at least a portion of the first display. In the content dock, respective contents may be displayed from top to bottom (or vice versa) in the order in which the contents are generated, and may be classified and displayed according to applications of the contents and/or types of the contents (e.g., image or text). The electronic device may determine the display order of graphic objects according to a designated order on a designated region of memory. The content dock may be visually distinguished from other icons of the home screen (e.g., shortcut icons of message, call, and the like), and may be displayed as it is, without relying on the change of the home screen (e.g., switching of the home screen page or execution of an application). To this end, the electronic device may generate the content dock as a layer separate from the home screen or another application execution screen, and may display the content dock as a higher layer.

According to certain embodiments, in operation 1670, the electronic device may receive input selecting at least one of the graphic objects of the content dock.

According to certain embodiments, in operation 1680, the electronic device may cause at least one content corresponding to at least one selected graphic object to be displayed on the first display, in response to selection of at least one of one or more graphic objects of the content dock. At this time, the processor may execute an application (e.g., a memo application or an image editing application) of the selected content, and may read out the content from the designated region in which the content is stored. The electronic device may run in an editing mode in which the content can be edited directly.

According to certain embodiments, when multiple graphic objects are simultaneously or sequentially selected from a content dock, the electronic device may cause multiple contents corresponding to the selected multiple graphic objects to be displayed on the first display in a multi-window.

According to certain embodiments, in operation 1685, in the state in which at least one content is displayed, the electronic device may edit the content in response to user input.

According to certain embodiments, there is provided a method of generating a content of an electronic device including a first display configured to be foldable and a second display. The method may include: generating at least one content based on user input on the second display in a state in which the first display is folded; detecting unfolding of the first display; and displaying at least one graphic object corresponding to the at least one generated content on at least a portion of the first display in a state in which the first display is unfolded.

According to certain embodiments, the method may further include an operation of storing the at least one generated content in a designated region of memory.

According to certain embodiments, the operation of generating the at least one content includes: an operation of generating a first content based on user input on a first application displayed on the first display; and an operation of generating a second content based on user input on a second application displayed on the first display.

According to certain embodiments, the method may further include an operation of identifying whether a stylus pen is removed from a recess in the electronic device in response to the unfolding of the first display. The operation of displaying the at least one graphic object may include an operation of displaying at least one graphic object on at least a portion of the first display when the stylus pen is removed from the recess.

According to certain embodiments, the operation of displaying the at least one graphic object may include an operation of displaying a content dock including the at least one graphic object on the at least a portion of the first display.

According to certain embodiments, the method may further include an operation of displaying, when at least one graphic is selected among one or more graphic objects of the content dock, at least one content corresponding to the at least one selected graphic object on the first display.

According to certain embodiments, the operation of generating the at least one content may include an operation of displaying, when multiple graphic objects are simultaneously or sequentially selected from the content dock, the multiple contents corresponding to selected multiple graphic objects on the first display in a multi-window.

What is claimed is:

1. An electronic device, comprising:
a housing including a first face and a second face;
a first display that is foldable, disposed on the first face of the housing;
a second display disposed on at least a portion of the second face of the housing;
a memory; and
a processor operatively connected to the first display, the second display, and the memory, wherein the memory includes instructions that, when executed, cause the processor to:
generate at least one content based on a user input on the second display when the first display is disposed in a folded state;
detect unfolding of the first display from the folded state to an unfolded state; and
display at least one graphic object corresponding to the at least one generated content on at least a portion of the first display when the first display is disposed in the unfolded state.

2. The electronic device of claim 1, wherein the user input is received before the first display is switched from the folded state to the unfolded state,
wherein the at least one generated content is stored in the memory.

3. The electronic device of claim 2, wherein the at least one generated content is stored in a predesignated region of the memory.

4. The electronic device of claim 2, wherein the instructions are further executable to cause the processor to:
generate a first content based on a user input on a first application displayed on the first display; and
generate a second content based on a user input on a second application displayed on the first display.

5. The electronic device of claim 1, wherein the user input includes a touch input or a hovering input generated using a stylus pen.

6. The electronic device of claim 5, wherein the housing includes a recess into which the stylus pen is removably insertable, and
wherein the instructions include instructions that are further executable to cause the processor to:
identify whether the stylus pen is removed from the recess in response to the unfolding of the first display,
wherein the at least one graphic object is displayed on the at least the portion of the first display when the stylus pen is removed.

7. The electronic device of claim 1, wherein the instructions are further executable to cause the processor to: display a content dock including the at least one graphic object on the at least the portion of the first display.

8. The electronic device of claim 7, wherein one or more graphic objects are displayed in the content dock, and wherein the instructions are further executable to cause the processor to:
when at least one graphic object is selected from among the one or more graphic objects of the content dock, display at least one content corresponding to the selected at least one graphic on the first display.

9. The electronic device of claim 8, wherein the instructions are further executable to cause the processor to:
when a plurality of objects are displayed in the context dock, and multiple graphic objects are simultaneously or sequentially selected from among the plurality of graphic objects displayed in the content dock, display multiple contents corresponding to the selected multiple graphic objects on the first display in a multi-window mode.

10. The electronic device of claim 7, wherein the instructions are further executable to cause the processor to:
display a floating icon on the first display in response to detecting the unfolding of the first display,
wherein the content dock is displayed in response to detecting selection of the floating icon.

11. The electronic device of claim 1, wherein, when the first display is disposed in the folded state, a first region and a second region of the first display are divided with reference to a line about which the first display is foldable are arranged to face one another, and
wherein the second display is disposed on a face of the housing that is opposite the first region, or a face of the housing that is opposite the second region.

12. The electronic device of claim 1, wherein the content includes at least one of a memo, a captured image, and a cropped image.

13. A method in an electronic device having a foldable first display and a second display, the method comprising:
generating at least one content based on a user input on the second display when the first display is disposed in a folded state;
detecting unfolding of the first display from the folded state to an unfolded state; and
displaying at least one graphic object corresponding to the at least one generated content on at least a portion of the first display when the first display is disposed in the unfolded state.

14. The method of claim 13, further comprising:
storing the at least one generated content in a predesignated region of a memory.

15. The method of claim 13, wherein generating the at least one content includes:
generating a first content based on a user input on a first application displayed on the first display; and
generating a second content based on a user input on a second application displayed on the first display.

16. The method of claim 13, further comprising:
in response to detect the unfolding of the first display, identifying whether a stylus pen is removed from a recess in a housing of the electronic device,
wherein the at least one graphic object includes is displayed on at least a portion of the first display when the stylus pen is removed from the recess.

17. The method of claim 13, wherein the at least one graphic object is displayed within a content dock.

18. The method of claim 17, wherein one or more graphic objects are displayed in the content dock, the method further comprising:
when at least one graphic is selected from among the one or more graphic objects of the content dock, display at least one content corresponding to the selected at least one graphic object on the first display.

19. The method of claim 18, wherein the generating of the at least one content includes:
when a plurality of graphic objects are displayed in the content dock, and multiple graphic objects are simultaneously or sequentially selected from among the plurality of graphic objects displayed in the content dock, multiple contents corresponding to the selected multiple graphic objects are displayed on the first display in a multi-window mode.

20. An electronic device comprising:
a housing;
a display that is foldable disposed on one face of the housing;
memory; and
a processor operatively connected to the display and the memory,
wherein the memory includes instructions that, when executed, cause the processor to:
generate at least one content based on user input on the display when the display is disposed in a folded state;
detect unfolding of the display from the folded state to an unfolded state; and
display at least one graphic object corresponding to the at least one generated content on at least a portion of the display when the first display is disposed in the unfolded state.
